(19) United States
(12) Patent Application Publication
(10) Pub. No.: US 2019/0318436 A1
(43) Pub. Date: Oct. 17, 2019

(54) FREE LEARNING ANALYTICS METHODS AND SYSTEMS

(71) Applicant: MICHAEL CEJNAR, NEW SOUTH WALES (AU)

(72) Inventor: MICHAEL CEJNAR, NEW SOUTH WALES (AU)

(21) Appl. No.: 16/306,013

(22) PCT Filed: May 31, 2017
(86) PCT No.: PCT/IB2017/000908

§ 371 Date: Nov. 30, 2018

Related U.S. Application Data
(60) Provisional application No. 62/343,824, filed on May 31, 2016.

(51) Int. Cl. G06Q 50/20; G09B 5/12; G06F 16/955

(52) U.S. Cl. CPC G06Q 50/205; G06F 16/955; G09B 5/125

(57) ABSTRACT

This invention concerns methods and systems for monitoring one or more students' use of computers, measuring, analyzing, and summarizing in statistical and pedagogical ways learning quality, on-task versus off-taskness, making diagnostic and prescriptive recommendations, and displaying relevant and configurable results in real time and historically in meaningful ways to students, teachers, and various educationalists and managers.

### TECHNICAL FIELD OF THE INVENTION

This invention is directed to methods and systems for monitoring one or more students' use of computers in an educational environment. In particular, the invention concerns methods and systems for monitoring, analyzing, and outputting data reflective of the totality of students' use of computers.

### BACKGROUND OF THE INVENTION

### 1. Introduction

The following description includes information that may be useful in understanding the present invention. It is not an admission that any such information is prior art, or relevant, to the presently claimed invention, or that any publication specifically or implicitly referenced is prior art.

### 2. Background

Many classroom management software applications and systems are available to provide screen monitoring, screen sharing or projection, collaborative screen windows, communication, transmission of data to and from a teacher to one or more students, collaborative work areas, and integrated assessment tools. These tools can show student screen thumbs and can display a student's whole screen if teacher suspects off-task use, but to do so the teacher must interact with the software via her/his computer and thus divert her/his attention from teaching in order to make decisions about the appropriateness of individual student's screen use. As will be appreciated, this becomes impractical in real-world classroom settings where, for example, there may be 25-30 students each using a different assigned computers.

Learning analytics (LA) is a new science that was started only about 3-5 years ago. It is distinct from academic analytics, which has been practiced for decades at universities, typically to predict student outcomes from enrollment data and to help direct interventions to improve student retention and experience. Recently, products marketed as being LA but in reality being nothing more than academic analytics have begun being targeted at primary and secondary schools even though they merely summarize and present student academic and demographic statistics, which are already available to those schools.

Learning analytics is a more pedagogically focused science, its most commonly-cited definition, adopted by the first international conference on learning analytics and knowledge in 2011 (LAK11), is “the measurement, collection, analysis and reporting of data about learners and their contexts, for purposes of understanding and optimizing learning and the environments in which it occurs”. It reflects a field at the intersection of numerous academic disciplines (e.g., learning science, pedagogy, psychology, Web science, computer science, etc.). LA is typically described to have 4 phases: descriptive, diagnostic, predictive, and finally, prescriptive. Tools used for LA include statistics, information visualization, and social network analysis. and educational data mining.

Learning analytics has so far only found early implementations in universities, usually in the context of collecting data from the back ends of massively open online courses (MOOCs) to measure student engagement by detecting when students log on, for how long, which modules, depth of student involvement in blogs, postings, noticeboards, etc. and how much they collaborate with other students. Current university LA implementations also attempt to measure learning styles, skills, and disposition by how long students spend on test questions, how many questions they answer correctly, how often they return to questions to try again, etc. Even so, LA analysis is limited to single MOOCs. LA is particularly needed for distance learning via MOOCs and in large university classes, where professors have little or no interactions with their students or awareness of their particular learning processes.

Thus, even though university environments are more and more employing learning analytics (LA) that use logged data from university online teaching platforms, these are unsuitable to the mostly unstructured computer use environment at secondary schools and its face-to-face teaching environment.

Currently no objective data is being collected on student use of computers in schools or at home. Research into students' computer use in schools is done almost exclusively with subjective and resource intensive questionnaires, diaries, observations, and case studies. There are no LA or other systems or products that can capture and provide analysis of the learning process, progress, or quality of computer use in primary or secondary settings, either in real time to aid teachers or historically for reflection.

Indeed, computer learning in schools is not producing the expected improved academic outcomes for students, teachers, and other stakeholders in the educational process, nor even the expected improvements in information and communications (ICT) skills. Educators are calling for currently unavailable objective data on how secondary school students use computers for learning in order to understand the learning process so they can develop effective strategies and pedagogy for teaching ICT skills and enhancing learning. Principals and other school administrators also need objective data to monitor the state of ICT learning in school and to evaluate programs, software tools, staff training, and the effects of interventions. Teachers also need live visibility of computer use in class to get feedback on the effects of their instruction, the learning progress of students, the utility of assigned resources and tools, and class engagement both during class and after for reflection in order to adapt learning design. More fundamentally, teachers also confess in focus groups their difficulties in monitoring and preventing distracting off-task use of up to 30 computers in a classroom. Students will also benefit from having carefully designed feedback on their own performance for self-assessment and self-regulation.

The inventors have discovered that the lack of automated capture, measurement, and analysis of computer learning and use in classrooms derives at least in part from (i) the perceived and real difficulties in obtaining meaning from raw activity logs, for example, a student's browser history, (ii) perceptions of privacy issues by students, teachers, and other stakeholders (e.g., parents, school administrators, etc.), and (iii) the need for yet another software product or system, which by its nature requires training and time, thus distracting from teaching.

This invention addresses these long-standing but unresolved needs by providing methods and systems to monitor one or more students' use of computers in an educational environment to analyze and output data reflective of some or all of the students computer use.

### 3. Definitions

Before describing the instant invention in detail, several terms used in the context of the present invention will be defined. In addition to these terms, others are defined elsewhere in the specification, as necessary. Unless otherwise expressly defined herein, terms of art used in this specification will have their art-recognized meanings.

An “activity block” refers to a block of computer activity(ies) with a predominantly similar educategory to identify a block of activity(ies) such as doing homework (e.g., for mathematics, etc.), watching a movie or video, listening to music, internet leisure browsing, etc., over certain duration or analysis time window (e.g., from 30 seconds, 1-60 minutes, 1-2 or more hours, etc.).

An “activity report” refers to a raw application or URL reported by the FLA application on a student's computer. An activity report may have an analysis time window, for example, of 0-10 seconds, 0-20 seconds, 5-30 seconds, or any other desired interval.

An “analysis time window” refers to an expected/desired duration of time, or “window”, sought for a particular activity or event to be analyzed in accordance with the invention.

An “application” is a computer program (i.e., a set of instructions to perform a specific task when executed by a computer) that performs a group of coordinated functions, tasks, or activities for the benefit of the user. A part of a computer program that performs a well-defined task is known as an algorithm. A collection of computer programs, libraries, and related data are referred to as software. Applications are usually implemented as software. Examples of applications include word processors, spreadsheets, web browsers, media players, and games. Application software typically refers to a collection of applications, whereas system software refers to computer programs such as operating system software (which runs the computer), utilities (which perform maintenance or general-purpose tasks), and programming tools (which are used to write computer programs).

Bloom's Digital Taxonomy refers to one example of a taxonomy of educational objectives, first published in 1956 (Taxonomy of Educational Objectives: The Classification of Educational Goals, Bloom, et al., published by David McKay Company, New York) to categorize and order thinking skills and objectives, which taxonomy was revised in 2001. Bloom's taxonomy is a set of three hierarchical models used to classify educational learning objectives into levels of complexity and specificity. The three lists cover the learning objectives in cognitive, affective, and sensory domains. In this invention, the focus is on the cognitive (knowledge-based) domain. The hierarchy proceeds from the lower- to higher-order thinking skills, as follows: remembering; understanding; applying; analyzing; synthesizing; and evaluating. As revised, the hierarchy (from lower- to higher-order thinking skills) is as follows: remembering; understanding; applying; analyzing; evaluating; and creating, and this invention derives measures of this hierarchy for computer learning. Other taxonomies, such as the Levels of Technology Implementation (LoTi) scale, are also applicable.

A “computer” is a general-purpose device that can be programmed to carry out sets of arithmetic or logical operations automatically. Since the device can carry out different sequences of operations depending on the programming then being acted upon, a computer can solve more than one kind of problem. A computer generally has at least one processing element, typically a central processing unit (CPU), one or more forms of memory, a power supply, and the circuitry necessary to operably connect the various components and any intended peripheral device(s), as well as the circuitry and components necessary to allow the computers connection to a computer network. The CPU carries out arithmetic and logic operations, and a sequencing and control unit can change the order of operations in response to stored information. Peripheral devices (i.e., input or output devices used to put information into or get information out of a computer, e.g., keyboards, computer mice, touchscreens, barcode readers, image scanners, digital still or video cameras, microphones, game controllers, displays, printers, projectors, audio speakers, etc.) allow information to be retrieved from an external source, and the result of operations saved and retrieved.

A “computer activity” refers to pre-processed activity report generated by an FLA application, for example, to remove noise, compress of multiple activity reports (e.g., having contiguous, overlapping, or periodic or non-contiguous analysis time windows of 1, 2, 5, 10, 15, 30, 45, 60, or more sec.) into one contiguous activity, matching the particular activity with known computer activities and associating that activity with a static educategory, etc.

A “computer network” refers to a telecommunications network that allows computers to exchange data. In such networks, networked computers (or other computing devices (e.g., mobile phones, tablet computers, servers, etc.)) exchange data with one or more other computers (nodes) in the network via a data link. Connections between nodes are established via cable and/or wireless connections. Examples of cable networks include those that utilize transmission lines, optical fiber, and the like. Examples of wireless networks (i.e., those wherein information can be transferred between two points, often by radio, light, magnetism, electric fields, or sound, that are not connected by an electrical conductor) include cell phone networks, wireless local networks, satellite communication networks, and terrestrial microwave networks. Networked computer devices that originate, route, and terminate the data are called nodes, which can include personal computers, smart mobile phones, servers, and other networking hardware.

A “data label” refers to an actual student activity description entered manually by a student or by an observer during computer data collection to label the data with the actual activity so that such information can be used in training an analysis engine to recognize the particular corresponding student activity.

The terms “displaying”, “causing to be displayed”, and analogous expressions refer to taking one or more actions that result in displaying. For example, a server computer may cause a web page to be displayed by making the web page available for access by a client computer over a network, such as the Internet, which web page the client computer can then display to a user, typically via an output device such a computer monitor or screen, the touchscreen of a mobile device (e.g., a smartphone or tablet computer), etc.

An “educategory” refers to an intrinsic category of computer activity, such as “learn”, “play”, “unknown” (unknowable), “system” (ignored), etc.

In this document, the words “embodiment,” “variant,” “example,” and similar expressions refer to a particular apparatus (or machine or system), process (or method), or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place or context may refer to a different apparatus, process, or article of manufacture. The expression “alternative embodiment” and similar expressions and phrases are used to indicate one of a number of different possible embodiments. The number of possible embodiments is not necessarily limited to two or any other quantity. Characterization of an item as “exemplary” or “representative” means that the item is used as a non-limiting example. Such characterization of an embodiment does not necessarily mean that the embodiment is a preferred embodiment; the embodiment may but need not be a currently preferred embodiment. All embodiments are described for illustration purposes and are not limiting unless otherwise specifically noted.

A “generic activity” refers to grouping of specific computer activities into a generic one, for example, grouping the use of Microsoft Word, Google Docs, or any other particular free or proprietary word processor as a generic “word processing” activity.

“LA” refers to learning analytics. “Free LA” (or “FLA”) refers to LA performed and integrated in the unconstrained free use of computers for learning, typical of secondary school education and life in general. “Open LA” refers to a multi-heterogeneous platform LA. “Structured LA” refers to LA performed within artificially structured environments such as MOOC or LMSs.

“Leaning complexity” refers to the cognitive level of thinking used in a particular learning activity, preferably with reference to Bloom's digital Taxonomy.

“LMS” refers to a learning management system, which is a software application for the administration, documentation, tracking, reporting, and delivery of electronic educational technology.

A “lesson activity” refers to a computer activity qualified with teacher's assigned activities to be assigned on-task, self-discovered on-task, or off-task, and predominant computer activity over the course of the assignment (e.g., 1-10 minutes). The lesson activity may also have an additional generic activity label, e.g. word editing, spreadsheet use, simulating, social networking, reading, etc.

A “MOOT” refers to a massive open online textbook.

The terms “on-task”, “on-taskness”, “off-task”, “off-taskness”, and the like refer to a context-interpreted category of computer activity as appropriate (on-task) or inappropriate (off-task) for the corresponding educational task.

A “patentable” composition, process (or method), machine (or system), or article of manufacture means that the subject matter satisfies all statutory requirements for patentability at the time the analysis is performed. For example, with regard to novelty, non-obviousness, or the like, if later investigation reveals that one or more claims encompass one or more embodiments that would negate novelty, non-obviousness, etc., the claim(s), being limited by definition to “patentable” embodiments, specifically excludes the non-patentable embodiment(s). Also, the claims appended hereto are to be interpreted both to provide the broadest reasonable scope, as well as to preserve their validity. Furthermore, the claims are to be interpreted in a way that (1) preserves their validity and (2) provides the broadest reasonable interpretation under the circumstances, if one or more of the statutory requirements for patentability are amended or if the standards change for assessing whether a particular statutory requirement for patentability is satisfied from the time this application is filed or issues as a patent to a time the patentability or validity of one or more of the appended claims is questioned.

A “personal computer” (e.g., a student computer) is a general-purpose computer whose size, capabilities, and price make it useful for individuals, and can be operated directly by an end-user (e.g., a student) without an intervening computer. Software applications for personal computers include word processors, spreadsheets, databases, web browsers, e-mail clients, digital media players, games, and personal productivity and special-purpose software applications. In the context of the invention, a personal computer will have an Internet connection to allow WWW access. Personal computers can be connected a local area network (LAN) or wide area network (WAN), either by a cable or a wireless connection. A personal computer may be, for example, a laptop computer or a desktop computer running an operating system such as Windows (Microsoft Corp.), Linux, or Macintosh OS (Apple).

A “server” is software or a computing device that provides functionality for other programs or devices, termed clients. In a client-server architecture, a single overall computation, series of computations, or processes may distributed across multiple processes or devices. Servers can provide various functionalities, often called “services”, such as sharing data or resources among multiple clients, or performing computation(s) for a client. A server can serve multiple clients, and a client can use multiple servers. A client process may run on the same device or may connect over a network to a server on a different device. A server is often more powerful and reliable than a standard personal computer, although large computing clusters composed of many relatively simple, replaceable server components can also be used as servers.

The terms “student action” and the like refer to student computer manipulations relevant to pedagogy, and include actions such as typing, mouse clicking, or copying/cutting to or pasting from a clipboard, etc.

“URI” refers to a string of characters that identify a resource and enables interaction with representations of the resource over a computer network, e.g., the World Wide Web (WWW) using specific protocols. Schemes specifying a concrete syntax and associated protocols define a URI. URLs are among the most common URIs.

“URL” refers to a Uniform Resource Locator, commonly informally termed a web or Internet address. It is a reference to a web (Internet) resource (i.e., a reference to any Uniform Resource Identifier (URI) that specifies the resource's location on a computer network and a way for retrieving it. URLs most commonly refer to web pages (i.e., pages on the WWW), but can also be used for file transfer, email, database access, and other applications. Most web browsers display a webpage's URL above the page in an address bar. A typical URL has the form: http://www.example.com, /index.html, which indicates a protocol (http), a hostname (www.example.com), and a file name (index.html).

A “web browser” (or “browser”) is a software application for accessing, presenting, and retrieving information resources accessible via a computer network. Commonly, a browser allows a user to access information available via the WWW, although they can also be used to access information provided by web servers in private networks or files in file systems. An “information resource” is identified by a URI or URL, and may be a web page, image, video, or other piece of content. Hyperlinks enable users easily to navigate their browsers to particular resources. Common browsers include Firefox (Mozilla), Internet Explorer (Microsoft), Google Chrome (Google), Opera (Opera Software), and Safari (Apple).

### SUMMARY OF THE INVENTION

This invention is the first to apply LA to the primary and secondary school environments. The inventors have termed the methods of this invention “free learning analytics” (FLA or Free LA) to reflect its analysis of the unconstrained, or “free” nature of computer use for learning by primary and secondary school students. Free learning analytics is distinguished from current LA forms, including open LA, which are perhaps better termed “structured LA” because those other LA methods analyze learning in artificially structured LMS environments.

For school students, integrated analysis of their actual free use of the computer and Internet is imperative, particularly since they do not learn via MOOCs and all of their computer use affects learning. Another key advantage of Free LA is its applicability to secondary school computer use, its total coverage of all learning resources and pedagogy styles, and its authenticity and seamless integration into learning.

A technical requirement of Free LA is that raw student computer usage data needs to be collected from each student's computer by a resident application, transmitted to a central server, stored, pre-processed to determine active use and the nature of the computer activities being performed before further heuristic analysis to determine the specific lesson activity and general student activity then being undertaken, such as studying, chatting online with other students, or engaging in non-learning activities, recognizing that for primary and secondary school students, all computer use affects learning, including off-task activities and activities bypassing a school's LANs by student's tethering to their mobile phones. In preferred embodiments, the FLA methods and systems of the invention capture a student's computer activities at school, such as in her/his in classroom(s), and optionally outside of school and at home, in recognition that all of a student's computer use, including use at home, affects computer learning.

Because student data is collected passively by an FLA system, where the student task and activity at any time may be initially unknown and thus has to be heuristically inferred from the data, the invention also provides processes and systems for “training” the system by data labeling from students, teachers, and other stakeholders. Thus, in contrast to the conventional LA methods, which deeply analyze student learning within a structured space of a single course (e.g., a MOOC) and assessment tasks constructed in an LMS, this invention provides heuristic methods that allow the FLA system to perform shallow but wide analyses of student computer activities, inferring the likely activity and its pedagogical parameters and value from recorded computer activities, student actions, and lesson context.

The invention also uses heuristic models to categorize in real time student activities into teacher-suggested on-task, self-discovered on-task, or off-task, using inputs from student activities, actions, lesson assigned activities, lesson times, and a database of activity categories. In some preferred embodiments, a dashboard displaying simple traffic light color-coded on-taskness for each student (and/or some or all students) in a teacher's class provides a useful engagement metric for use in class in real-time or after class for reflection. In preferred embodiments, such a display can be understood at a glance, rather than requiring screen monitoring, which takes mental processing to analyze and determine if a student is on-task and thus distracts from teaching. In some of these embodiments, the FLA system categorizes, processes, and diagnoses student computer activities into levels of on-taskness, which is then indicated to the teacher (or other stakeholder) in a readily appreciated binary (e.g., plus or minus, thumb's up or thumb's down, etc.) or color-coded display for each student in the teachers classroom on one screen to convey to the teacher the engagement of the entire class with one glance.

Other embodiments of the invention concern analytical tools for appropriately detecting and analyzing higher order and longer time scale activities and activity blocks and displaying such information interactively and/or as reports for teacher reflection and further analysis and evaluation by other stakeholders. In some of these embodiments, activities are analyzed according to their likely cognitive complexity and sophistication of the activity. In some of these embodiments, a student's computer activities are analyzed in conjunction with, for example, the student's acts of typing, mouse use, and/or clipboard use to further qualify likely cognitive and creative complexity during learning.

In some embodiments, the FLA methods and systems of the invention analyze student activities in relation to the timing of a student's computer use, patterns of interruption, category(ies) of interrupting activities, dwell time on one category or on a category of activities, duration of prevalent activity categories (which may include ignoring shorter interrupting categories), all of which allow inference of student attention, distractibility, multitasking. and self-governance.

In some embodiments, the FLA methods and systems of the invention provide an analysis of the time course of activities to identify repetitive use of one or defined groups or combinations of activities to allow inference of specific, more complex student activities.

In some embodiments, the FLA methods and systems of the invention allow assessment and analysis of Internet search behavior and skills, as may be indicated, for example, by search engine or database use, search operators and tools used, the nature of search text strings used, including the number of terms used, and analysis of the student's pattern of search result inspection, selection, and use of any refining searches.

In some embodiments, the FLA methods and systems of the invention provide for the display of a time sequence of activities of one or more students with a common adjustable time scale, with activities coded (e.g., color-coded) by one of their categories along with any associated typing, mouse, and/or clipboard use by the student, thereby allowing exploration of student activity data during lessons or any time for discovery of pedagogically meaningful patterns.

In some embodiments, the FLA methods and systems of the invention provide for the analysis of the amount and quality of a student's information and communications technology (ICT) and understanding, which information can be used to assess or measure the student's ICT skills. Similarly, in some embodiments the invention provides for the analysis of student activity data relating to Internet search patterns and skills to provide a measure of the student's information literacy. Similarly, in some embodiments the invention activity data to be categorized by required or associated level of thought complexity, innovation, creativity, collaboration, and communication, which information can, if desired, be combined with, for example, measures of ICT skills and information literacy to provide an integrated measure of 21st century learning.

Still other embodiments of the invention concern student activity data disclosure. In some embodiments, the systems of the invention address the different privacy requirements of various stakeholders, including students, teachers, and schools, and thus allow configurable compartmentalization and de-identification of student computer activity data for different time periods and according to viewer and audience (e.g., student data or information visible to a teacher may be different than the data and/or information accessible by the student, a student's parent or guardian, and/or a school administrator or third party granted access to the data for academic or commercial research purposes). In some of these embodiments, student data is rendered anonymous or converted to class or grade year statistics.

In still other embodiments, the systems of the invention are configured to communicate an alert, a notification, and/or a push notification related to specific data included in a student's meaningful FLA data as a result of a comparison of such data to one or more threshold conditions. A notification may be anything, for example, an e-mail, an SMS, a mobile text message, and/or a web-based alert such as a social network message or a message specific to an application running on a user client device.

Various features and advantages of the invention will appear from the following description in which the preferred embodiments have been set forth in detail in conjunction with the accompanying drawings.

### BRIEF DESCRIPTION OF THE DRAWINGS

In this specification, reference will be made in detail to several embodiments that are illustrated in the accompanying drawings. In the drawings, the same reference numerals and corresponding descriptions are used to refer to the same apparatus elements and method steps. The drawings are in a simplified form, not to scale, and omit apparatus elements and method steps that can be added to the described systems and methods, while possibly including certain optional elements and steps.

FIG. 1 shows a representative example of a live, or real-time, classroom engagement page view, or dashboard, produced in accordance with the invention, which view simultaneously shows for each of 24 students her/his respective on-taskness (shown here in grey scale; preferred implementations utilize different colors), computer activity, mapped lesson activity, and history (represented here as length of time the student was engaged in the represented activity).

FIG. 2 is a schematic that shows the data elements represented in each tile of the classroom engagement page view, or dashboard, shown in FIG. 1.

FIG. 3 shows a representative classroom engagement history graph that can be generated using the computer systems of the invention. This graph historically illustrates over thirty minutes (from 09:00 am to 09:30 am) the number of students using their computers to engage in a particular educational activity (i.e., education (edu-) category).

FIG. 4 shows a representative learning flow visualization tool (i.e., a learning flow page) to represent certain meaningful FLA data for one or more students.

FIG. 5 shows a zoom-in/zoom-out functionality that can be used in conjunction with visual representations, here, StudyBars, of certain meaningful FLA data for one or more students. Which meaningful FLA data is displayed (here or in any circumstance in practicing the invention), and for which students, may be customized by a user, depending on the context.

FIG. 6 shows StudyBars (i.e., preferred visualization tools) for three students that display certain student actions, here, typing and clipboard use.

FIG. 7 shows compressed StudyBar variants for 10 actual students in a real-word classroom setting.

FIG. 8 shows meaningful FLA data for a hypothetical student displayed on a Teacher dashboard. The represented meaningful FLA data summarizes some of the student FLA data that may be collected, analyzed, and displayed to show the student's (or a plurality of students') on-taskness and off-taskness, top resources used, lesson engagement (here, plotted graphically), and home-versus school-work over the course of a single day to a third party (e.g., and authorized teacher) using the methods and systems of the invention. Such data can be used, for example, for teacher reflection and/or future planning for the particular student.

FIG. 9 is an overview of the methods of the invention that shows the flow of student activities and information detected on a student's computer.

FIG. 10 is a flow chart showing a representative example of a learning analytics (LA) toolbox algorithm useful in practicing some embodiments of the invention.

FIG. 11 is a flow chart showing a representative example of a computer activities collection algorithm useful in practicing some embodiments of the invention.

FIG. 12 is a flow chart showing a representative example of an update method for an activities categorization database useful in practicing some embodiments of the invention.

FIG. 13 is a flow chart showing a representative example of an activity categorizer algorithm useful in practicing some embodiments of the invention.

FIG. 14 is a flow chart showing a representative example of an activities matching algorithm useful in practicing some embodiments of the invention.

FIG. 15 is a flow chart showing a representative example of an activity/lesson contextualizer algorithm useful in practicing some embodiments of the invention.

FIG. 16 is a flow chart showing a representative example of a learning analytics (LA) toolbox algorithm useful in practicing some embodiments of the invention.

FIG. 17 is a flow chart showing a representative example of a computer activity group lookup algorithm useful in practicing some embodiments of the invention.

FIG. 18 is a flow chart showing a representative example of a student activity block finder algorithm useful in practicing some embodiments of the invention.

FIG. 19 is a flow chart showing a representative example of a higher order-thinking algorithm useful in practicing some embodiments of the invention.

FIG. 20 is a flow chart showing a representative example of a behavioral analysis algorithm useful in practicing some embodiments of the invention.

FIG. 21 is a flow chart showing a representative example of an Internet searching analyzer algorithm useful in practicing some embodiments of the invention.

FIG. 22 is a representative table listing generic computer activities and their cognitive level ranges.

FIG. 23 is a flow chart showing a representative example of an student learning activity analysis hierarchy useful in practicing some embodiments of the invention.

FIG. 24 is an illustration of a representative FLA system architecture according to the invention.

### DETAILED DESCRIPTION OF THE INVENTION

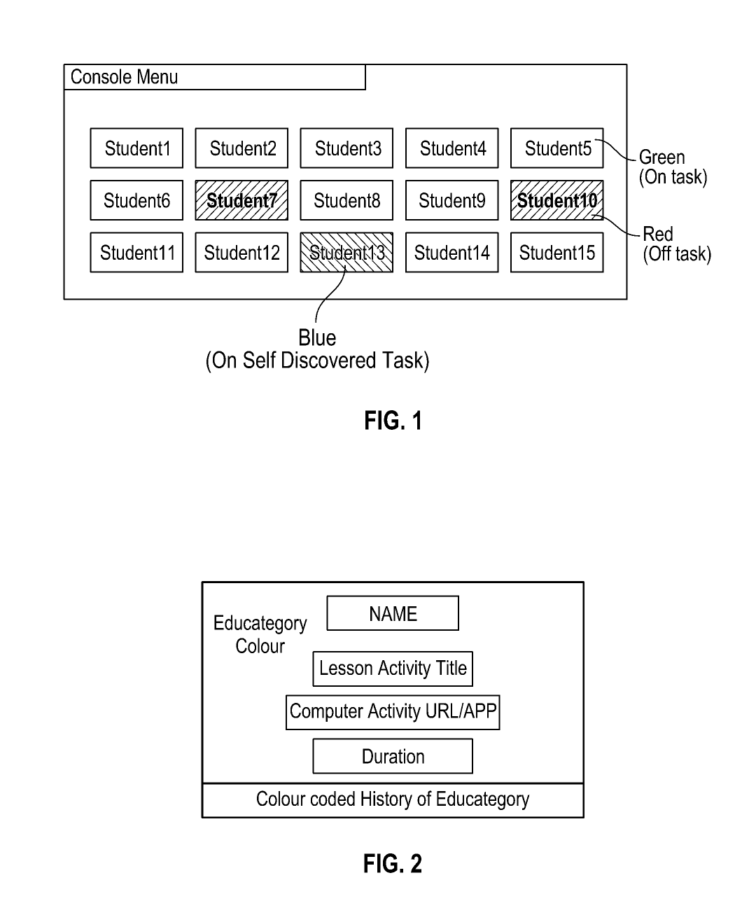

In the following detailed description, reference is made to the accompanying drawings (FIGS. 1-24), which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented here.

### REPRESENTATIVE EMBODIMENTS

The following descriptions illustrate several preferred exemplary embodiments of the invention by reference to the accompanying drawings.

FIG. 1—Live (Real-Time) Classroom Engagement Pages. FIG. 1 shows a representative view of a real-time classroom engagement page that can be displayed on a teachers computer monitor. This dashboard view shows for each of 24 students in the class her/his current activity, and whether s/he is on task, which on-taskness in this example is coded in grey-scale. Even more preferably, on-taskness could be color-coded using a simple a traffic color code to reduce teacher cognitive load. For example, on-taskness could be shown in green, partial on-taskness in yellow, and off-taskness as red. If desired, more and/or different colors and/or degrees of shading could be used. For example, in a preferred non-limiting embodiment, the tiles for those students “on-task” for assignment assigned by the teacher for the particular academic subject are shown in green (represented as “1” in FIG. 1), students engaged in activities other than the assigned activity, determined by LearnMeter (see, e.g., the website for learnmeter.com) to be nevertheless either appropriate for the subject or, optionally, broadly educational, are termed self-discovered on-task activities and are color-coded Blue (represented as “2” in FIG. 1), non-educational, or optionally educational activities inappropriate for the class, Off-task activities are coded red (represented as “3” in FIG. 1), unknown or ambiguous category activities are coded orange (represented as “4” in FIG. 1), and off-line students grey (represented as “5” in FIG. 1).

FIG. 2—Data elements of Student Icons/Tiles. FIG. 2 schematically illustrates a representative individual student tile of the sort shown in the screen shot represented in FIG. 1. In this embodiment, the tile of the real-time or (“live”) in classroom engagement page shows the particular student's login name (“Name”), the title of the activity s/he is then engaged in (“Lesson Activity Title”), the computer application and URL then being used by the student (“Computer Activity URL/App”), and how long the student had then been using the particular computer application or URL (“Duration”). A history of the student's on-taskness could also be displayed, for example, to indicate the student's on-taskness between the teachers observations of the particular page view, thereby reducing the need for frequent referral to the page, shown in this non-limiting example as a bar at the bottom of the tile with a color-coded history of on-taskness for the lesson, the full width of the icon representing the duration of the lesson. As will be appreciated, alternative representations could show other relevant variables, such as the activity group, i.e., an adjustably time-smoothed activity to reduce frequency of change or a cumulative duration of shown activity for the lesson. Activity URLs may also be shown as a hyperlink, thereby allowing the teacher (or other authorized viewer) to quickly and easily navigate to the same Internet page as the student corresponding to the particular tile is then using so that the teacher (or other viewer) can easily open that web page simply by clicking on the link.

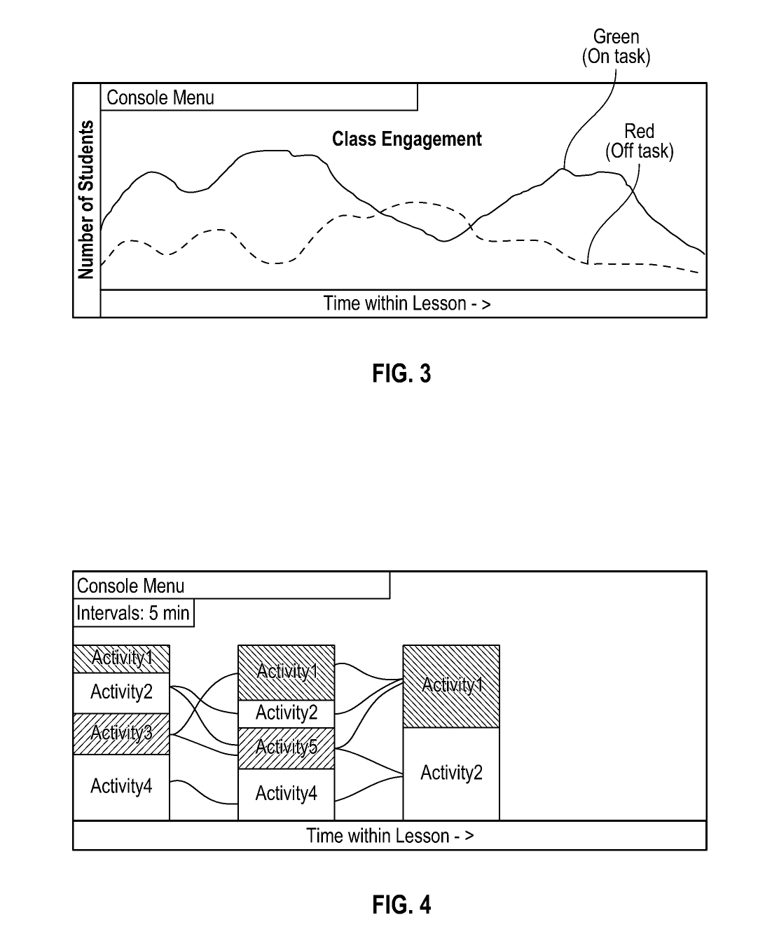

FIG. 3—Classroom Engagement History Graph. FIG. 3 is a representative graph that may be generated while carrying out certain embodiments of the invention. FIG. 3 is another useful and minimally distracting method of displaying a classroom's engagement in respect of particular lesson. As shown, this graph plots the time-variant total number students on-task, shown by the upper curve, versus the number of students off-task during the same 30-minute period, as shown by the lower curve.

FIG. 4—Learning Flow Page, Computer Activity Titles. Activity data gained by the methods of this invention also allows the display of students' learning flow and activity congruence between students over time (or at various times or time intervals) during, for example, a lesson. In a preferred embodiment, such data may be displayed as shown in FIG. 4, which shows groups of students engaged in the same activities as colored blocks, every 1 to 5 minutes, with movement of students between activities indicated by lines joining the activity blocks. In FIG. 4, line thickness is proportional to the number of students flowing between activity blocks. Preferably, activity blocks are labeled with activity information and are color-coded. If desired, such color-coding may correspond to the color codes used in the context of a live classroom engagement page (see FIG. 1, above) or with other relevant information. Clicking on a particular block, as represented by the black box that lists students' names then engaged in the particular activity, may reveal students represented by the block or other information about the activity. In some embodiments, the invention allows a user viewing such activity data to select a single student, in which event the activity blocks and lines reflecting movement between different activity blocks for that student may optionally be highlighted.

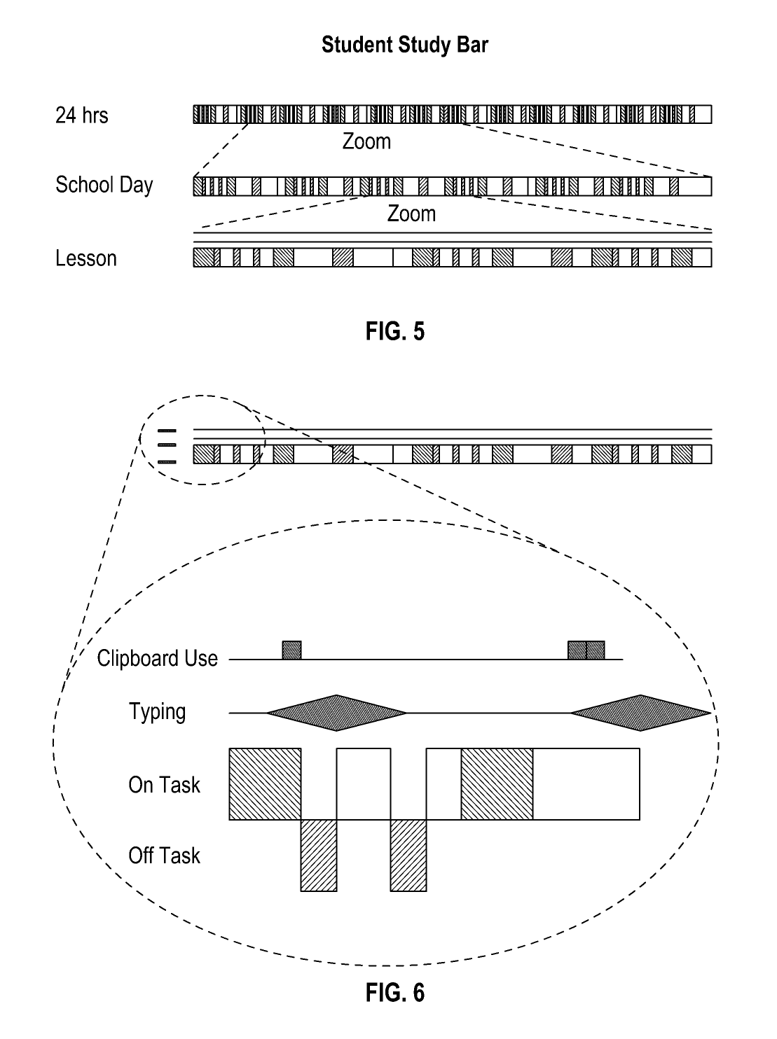

FIG. 5—StudyBar Zoom-In/Zoom-Out Functionality. FIG. 5 shows an optional feature of the invention that allows presentation of color-coded on-taskness to usefully show a student's study history for an arbitrarily selected period of time throughout, for example, the day, week, month, grading period, or the like for closer analysis, using, for example and as shown in FIG. 5, a time line and calipers movable by a computer mouse. In the embodiment shown in FIG. 5, a user expands the 24-hour history shown in the upper timeline to focus on just the school day period in the middle timeline. The user then further zooms in on a portion of the school day timeline (middle timeline) to expand the 1-hour period shown in the timeline at the bottom of the figure.

As will be appreciated, where color-coding is mentioned as a visualization tool, any other suitable tool or visual aid can be employed to distinguish differences in the metric(s) being considered. For example, a metric may be represented as a geometric shape, the size of which may vary to reflect differences in metric over time, between students, etc. Also, the invention contemplates combining visualization tools (e.g., color-coding and differently sized geometric shapes for different metrics) in various embodiments.

FIG. 6—StudyBar of 3 Students Showing Student Actions—Typing and Clipboard Use—In Enlarged, Detailed View. The StudyBar visualization tool shown in FIG. 6 shows three horizontally arrayed StudyBars, one for each of three students between 1 pm and 2 pm, to represent on-taskness of tasks by colors as described in the context of the embodiments represented by FIG. 1. As shown in FIG. 6, offsetting off-task data below the on-task data can further enhance the visualized on-taskness data. A StudyBar may also be used to visualize a student's frequency of actions associated with her/his activities, such as typing (indicated in FIG. 6 by vertical lines above activities) and/or use of a clipboard functionality to “cut”, “copy”, and/or “paste” data (indicated in FIG. 6 by dots above the typing (keyboard icon) display). Such visualization tools allow the analyst/user to further qualify the cognitive level of a student's activities according to her/his actions. For instance, where active typing may indicate a creative process, frequent use of a clipboard indicates that the student is engaged more in data gathering or copying activity, whereas the absence of any action indicates passive reading or viewing. In preferred embodiments, hovering the mouse over any colored activity block in such a visualization yields the display of pertinent activity information and a corresponding hyperlink if the activity is a URL.

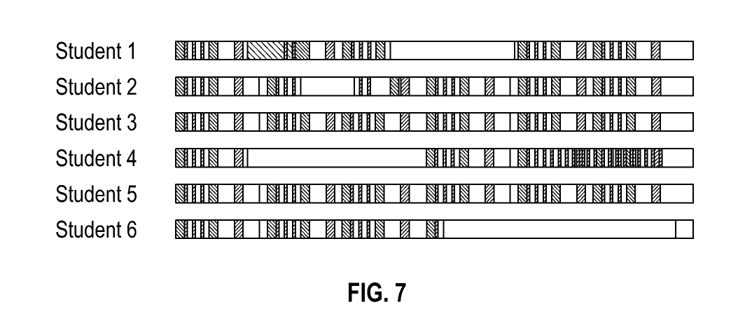

FIG. 7—Compressed StudyBar Variant of 10 Students Showing On-/Off-Taskness. FIG. 7 shows a page view of meaningful FLA data for each of 10 students during the course of a lesson over a I-hr. period (for example, from 10:00-11:00 am) in a real-world classroom setting. In this view, each student's meaningful FLA data is represented as a StudyBar. In this view, the students' StudyBars are variants set up to show only color-coded (in grey scale) on-taskness (light grey) or off-taskness (dark grey). The FLA data represented in these StudyBars revealed four students to be off-task for most of the lesson (see dark grey shading).

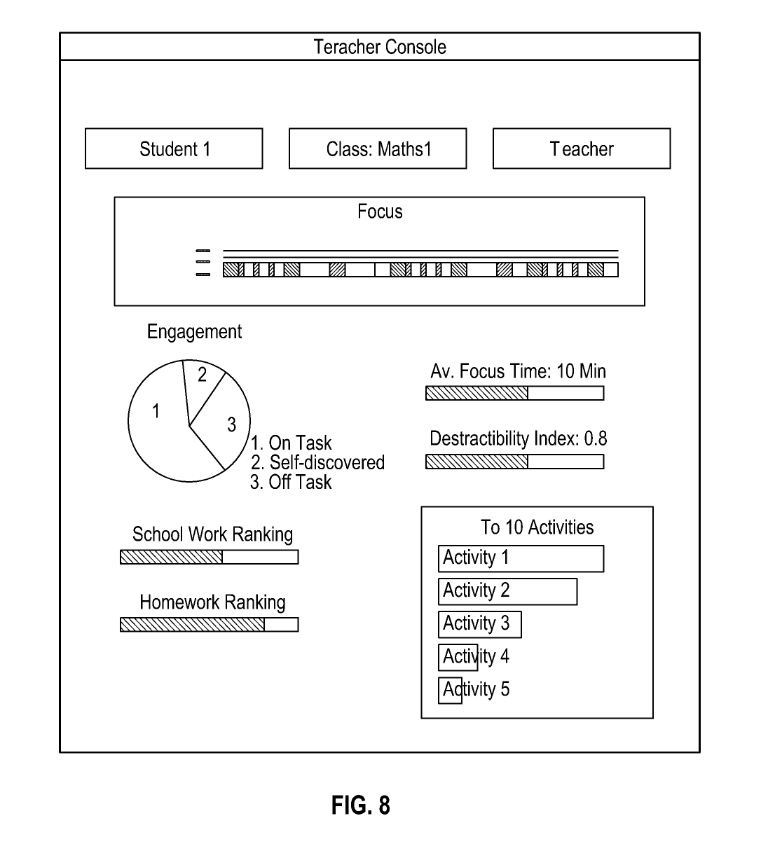

FIG. 8—FLA Lesson Summary Display. Various analyses of some or all of the meaningful FLA data for one or more students obtained using the instant methods and systems can be shown in a multitude of ways for teacher and educator reflection and analysis, which would be apparent to those skilled in the art. One of a multitude of methods is shown in FIG. 8, which, at the top of the page shown here, shows for an individual student his StudyBar as described in FIG. 6, a doughnut chart showing proportions on-task versus off-task activities (i.e., “on-taskness” and “off-taskness”, respectively) for the particular lesson, “Focus Time” representing the average time the student spent performing on-task activities, a “Distractibility Index” to show how many off-task activities the student engaged in during the period under consideration, “School Work” and “Home Study” bar graphs to show the amount of time the student spent working on-task at school and at home, respectively, and “School Work Ranking” and “Home Study Ranking” charts that plot the student's rank among classmates for configurable parameters such as total study time, fraction of on-task time spent on computer, cognitive level of study time, or any useful combination of these, particularly as may be validated to be predictive of student academic outcomes.

### System Flow Charts

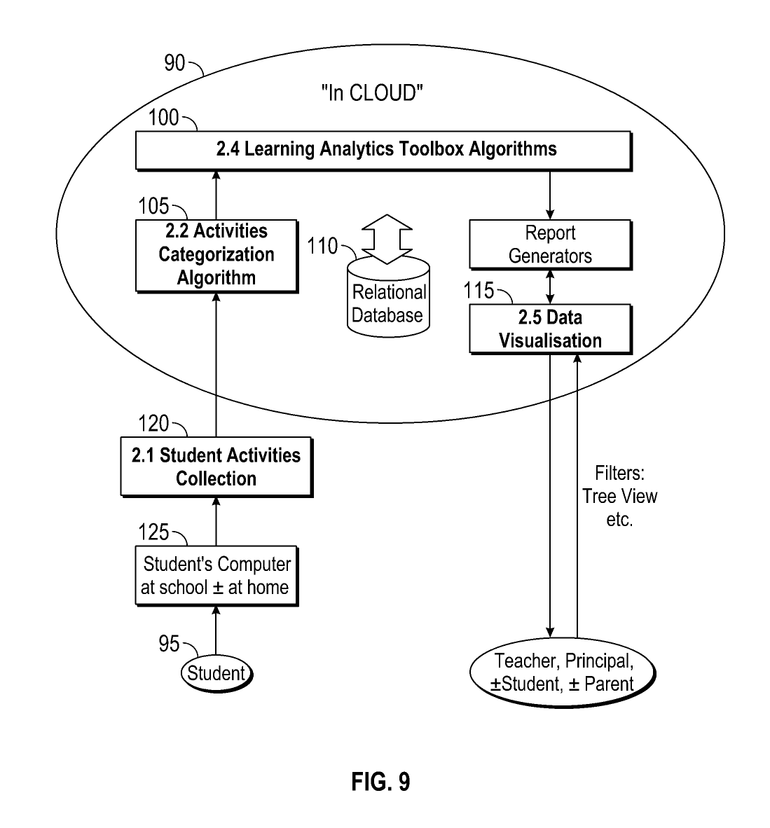

FIGS. 9-21 describe flow charts of various processes used by the FLA software of the invention. These (and other) processes used in the practice of the invention can be implemented using any suitable algorithm(s) in any suitable programming language.

FIG. 9. Top-level Architecture. FIG. 9 provides an illustrated overview of the methods of the invention that shows the flow of information and student activities detected on a student's computer (125), which could be her/his assigned laptop (or tablet or other computing device suitable for use in an academic setting) located at school, at home (e.g., the student's personal or family's computer), or her/his account accessed via a terminal on a school computer. The student (95) can be any person of any school age or of university age, or, alternatively, an employee or any adult in need of, for example, understanding her/his computer use, timing, and effectiveness, participating in coursework toward an academic degree, professional or other certification, or the like.

The student's activities on her/his computer, terminal, etc. are collected by an FLA application (120) resident on her/his computer, the mainframe connected to the terminal, etc. The FLA application (120) collects raw data related to the student's use of various other applications on her/his computer, for example, word processors, spreadsheets, presentation preparation applications, photo editors, web browsers, games, etc. In the case of web browsers, the FLA application (120) also collects the Internet domain(s) being accessed. The raw data may be collected and stored on the student's computer for later transmission (sharing), preferably via a public or other Internet (or other local or wide area network (LAN or WAN, respectively)) connection to a server computer on the network; alternatively, the FLA application (120) can direct the data's immediate transmission elsewhere across the network, as it is collected. As a representative example, the raw data can be transmitted via an Internet connection to a LearnMeter™ server in the cloud (90), where the data may be stored, for example, in a relational database (110), categorized from specific to generic activities using an activities categorization algorithm or engine (105), and analyzed into pedagogically meaningful FLA information, for example, by a collection (or toolbox) of heuristic LA algorithms (100).

Reports about the student's activities can be generated by the cloud-based server using the meaningful FLA data generated from the analyses performed by the heuristic FLA algorithms (100). If requested by an authorized user (e.g., the student's teacher), a report may be prepared and delivered across the network (e.g., the Internet) to the user's computer. Reports of various types can be generated, including standard, system-generated reports using standard forms and templates. If desired, the user may also generate custom reports having a general or specific format, for example, a standard format prepared by the service provider that makes the system available to the particular students and other authorized users (typically for a fee), which report format may, for example, be designed to minimize the cognitive load on the stakeholder (i.e., authorized user) (115) requesting or viewing the report. In an alternative embodiment, the system elements described as residing in the Cloud could be located on a server in the school or similar institution (for example, as part of a WAN hosted and maintained by a large institution, or group of institutions, for example, a school district with several schools, a university system, a large corporation, etc.).

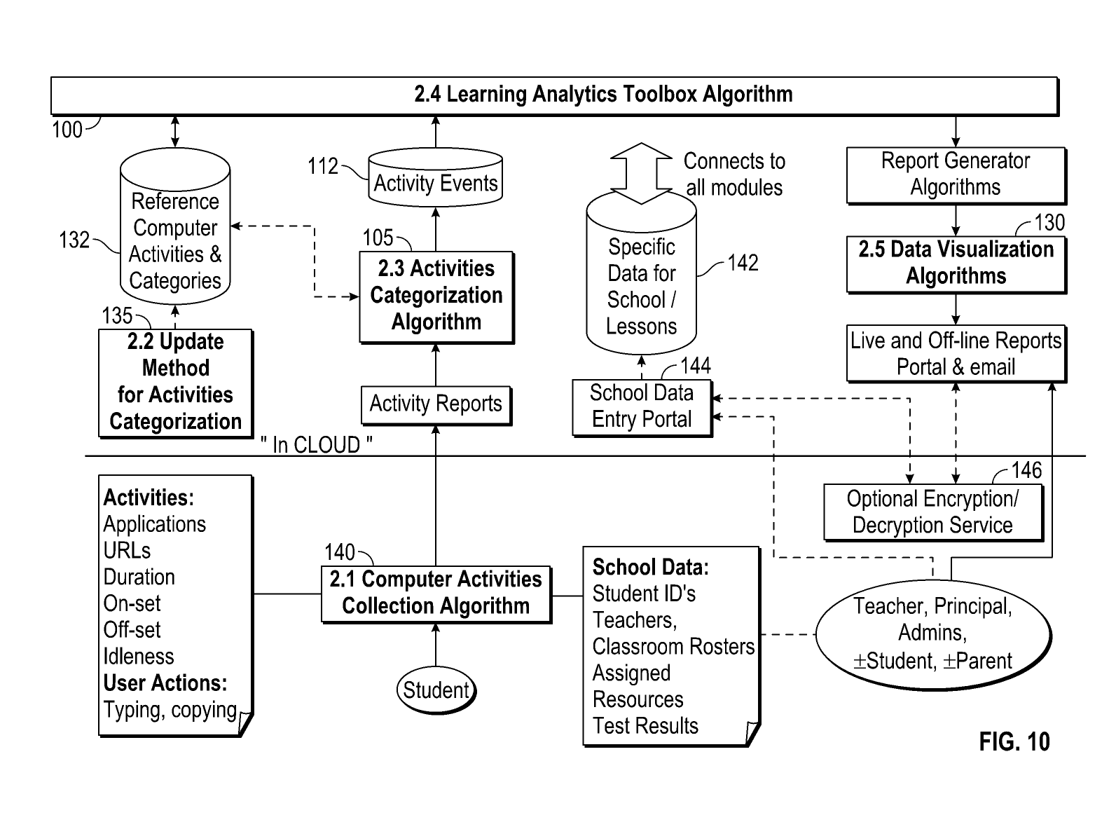

FIG. 10—Learning Analytics (LA) Toolbox Algorithm (100). This figure shows a more detailed view of some of the inventions element, namely, the Learning Analytics (LA) toolbox algorithms (100) from FIG. 9. The process begins through the use of a computer activities collection algorithm (140) embodied in an activities collection application to collect raw data about the totality of the student's use of her/his computer. The activities collection application collects raw data about each application used and computer activity (e.g., typing (up to and including recording each keystroke), mouse use (e.g., to navigate, to select text, to cut, copy, paste, etc.), etc.) preformed by the student. In those instances where the student uses a web browser, the activities collection application records the URL(s) and page title(s) being viewed by the student, as well as the time (e.g., onset, offset time and/or or duration) and whether student is actively using the computer (e.g., by scrolling up and/or down, navigating between pages, etc.) or whether the computer is idle (again, based on the input(s), or lack thereof, into the computer received from the user).

In some embodiments, the activities collection application detects and reports user actions, for example, typing and/or clipboard use for, for example, copying and pasting, which in some of these embodiments may be used to further qualify the educational value of particular activities carried out by the student. From this raw data, the activities collection application generates activity reports. Preferably, the activity reports are transmitted to the FLA server (in this example, the FLA server a Cloud-based server). The information in an activity report may then be categorized by a heuristic activities categorization algorithm (105) into a category, for example, of “learning”, “non-learning”, or “unknown” using a lookup table stored in a database (132) accessible by the FLA application running on the FLA server. The results may then be saved as particular activity events. The FLA application can also call on other databases, for example, a database (142) that contains data on specific assignments assigned by the student's teacher(s). That information may also be integrated with the student activities categorization to provide even more specific definition of the particular activity(ies) as activity event(s), which can be stored in an other database stored in database 142 to become Activity Events, stored in an activity events database (112). Data for the student from the activity events database can then be input to the LA toolbox algorithm/application.

The school can enter identifying data about the student manually, using transfer files, or by an automated process from data stored on the school's server. Such information may, for example, include, student-specific information (e.g., age, gender, class, parent(s) and/or guardian(s), etc.), the names of and other information about student's teacher(s), classroom rosters, assigned computer(s), internet resources for a particular academic subject, class and/or project name, and test results. Student identity may be optionally encrypted and decrypted on a school encryption server, so, for example, all information leaving the school is de-identified.

In preferred embodiments, the activities categories database (132) and other databases (e.g., the assignments database (142)) is routinely updated, manually or, preferably, by an automated process such as via an update engine (135).

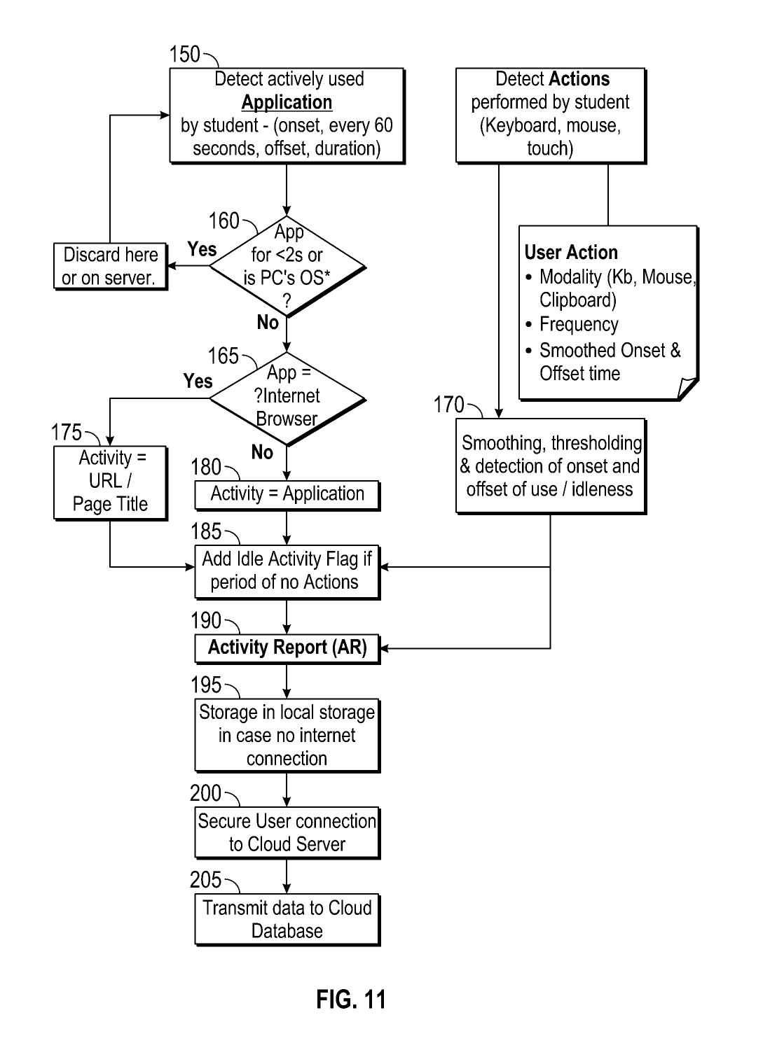

FIG. 11—Computer Activities Collection Algorithm (140). This figure describes a representative computer activities collection algorithm that can be used in practicing the invention. This algorithm, and software (or other computer control logic) provides the following functionalities:
Capture of each new active window process name (e.g., by application name, e.g., Microsoft WORD) and its window title
Capture of each new URL as it becomes an active tab in active web browser, as well as capture of each tab title (e.g., the website whose is “URL: https://play.spotify.com/genre/decades with Tab Title: Beds Are Burning—Remastered—Midnight Oil Spotify”)
Capture in character (e.g., keystroke) and/or time the onset and offset of keyboard and mouse use (e.g., click, drag, etc.).
Capture each clipboard use
Report each of the above every time

Now, by reference to FIGS. 10 and 11, a computer activities collection algorithm (140) resides in the FLA application on the student's computer. Initially, it detects active use of any third party application (e.g., a word processor, spreadsheet, web browser, game, photo editor, audio/video player, etc.; 150). Sensing/detection of active use is preferably performed continuously and then reported or logged at periodic regular intervals (e.g., 2, 5, 10, 30, 60, 100, 300, or more seconds, etc.). Preferred meaningful intervals are those that range from about 2 seconds to about 600 seconds, preferably from about 10 to about 300 seconds, depending on, for example, the competing priorities of data granularity versus consumed bandwidth by frequent transmission of data. Sensing/detection can be accomplished by continuously querying the foreground activity or window from the computer operating system and by detecting any change to it. This may be achieved by a suitable operating system interface, such as an accessibility interface in Microsoft Windows, or, if no such accessibility interface is present, by accessing a browser's history file or by a custom service program inserted into the operating system. Activities are first cleansed (160) by discarding those that are very brief (e.g., less than about 2 seconds) or that belong to an internal computer processes determined, as may be assessed by comparison of the program or file name to a those in lookup table.

If an application is determined not to be an Internet browser or an internal computer processes, for example, by comparing (165) the application's name (or other identifier) to those listed in a lookup table, then the activity is deemed to be an active application and its name and its window title, if available, are recorded. If the application is determined to be an Internet browser, then the URL and the browser title of the foreground tab is recorded as the activity. In preferred embodiments, an important criterion for being deemed to be an active application is whether the user (i.e., student) is actively using the particular application. This is detected (155) by monitoring for user inputs such as keyboard use, mouse movement or clicks, screen touch (for devices that employ touchscreens), etc. This data is processed (170) with time averaging and, if no input is detected for a timeout period (or threshold) such as 60 seconds, but which could be any suitable value to indicate inactivity (e.g., from 5 seconds to 300 seconds), then a special “idle” flag is added to the activity (185).

An “activity report” containing activity descriptors as already listed (140) is assembled (190), and if no Internet or other network connection is then available, the activity report is stored locally until the Internet (or other network) connection becomes available, whereupon the activity report is transmitted, preferably securely (200) to the Cloud-based FLA server (205).

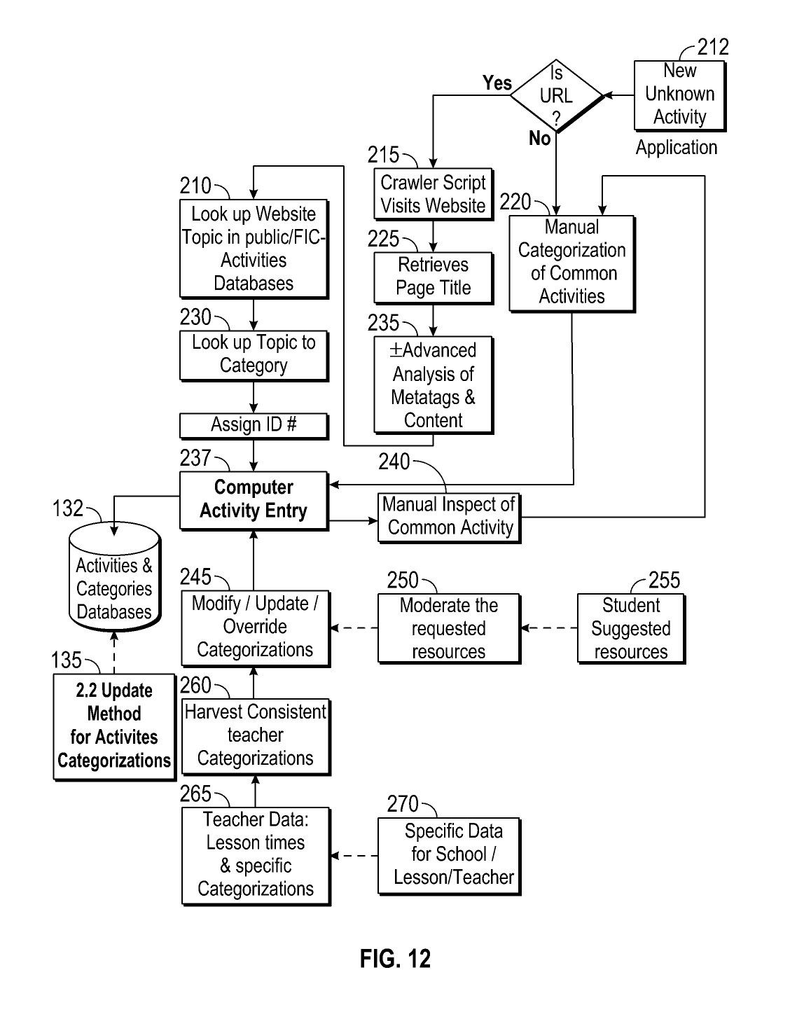

FIG. 12—Item 135 (FIG. 10), Level 2.2 Update Method for Activities Categorization Database. This figure provides a detailed flowchart of a representative example of the “update engine” (135) depicted in the representative process shown FIG. 10. FIG. 10 shows a preferred method for updating the categories database (132) to include information about newly detected “unknown” (or unrecognized) activities, i.e., activities performed by a student on her/his computer that are not then represented in the categories database (132). In the exemplary, non-limiting updating method illustrated in FIG. 10, new “unknown” activities (212) that are not accessed by or performed using a web browser (e.g., are non-URL applications) are in practice generally few and, if and when detected, may be categorized manually by inspection (220). Alternatively, a computer-search method could be employed to search online, for example, to identify one or more key words about the new unknown application and then use those words to search for comparable or equivalent functionality in one or more other applications. If one or more other applications are identified, those could then be compared with data in the categories database (132) to determine if categorization is then possible. If so, the category assigned for the “unknown” application would be that of the corresponding “known” application(s) in the categories database (132); if not, the “unknown” application could be flagged for additional machine-based searching and/or manual curation and database updating.

With regard to activities that are URLs, in this embodiment each URL is stripped of its specific resource URI and its remaining domain name is attempted to be matched with activity domains in the categories database to identify the activity. If the domain name is new, it is visited by an automated “crawler” script (215) to retrieve the domain page title (225) and, preferably, any meta-tag information, which title and/or meta-tag information may be further analyzed for educational and/or other significance (235). The domain name may then be looked up in one of a number of proprietary, non-public or public website databases to determine the domain's general topic (210). The topic(s) thus identified can then be mapped onto an educational category via a lookup table (230) together with the domain name and tab title generate a new categorized reference computer activity (237) stored in the categories database (132).

In some embodiments, common computer activities characterized in the categories database (132) are periodically inspected by human experts (240) and manually categorized, if necessary. Teacher- or school-assigned resources (270) can be harvested for consistent categorization (265, 260), and together with moderated user-suggested or -requested categories (255, 250), can be used to override (245) categories in the categories database (132).

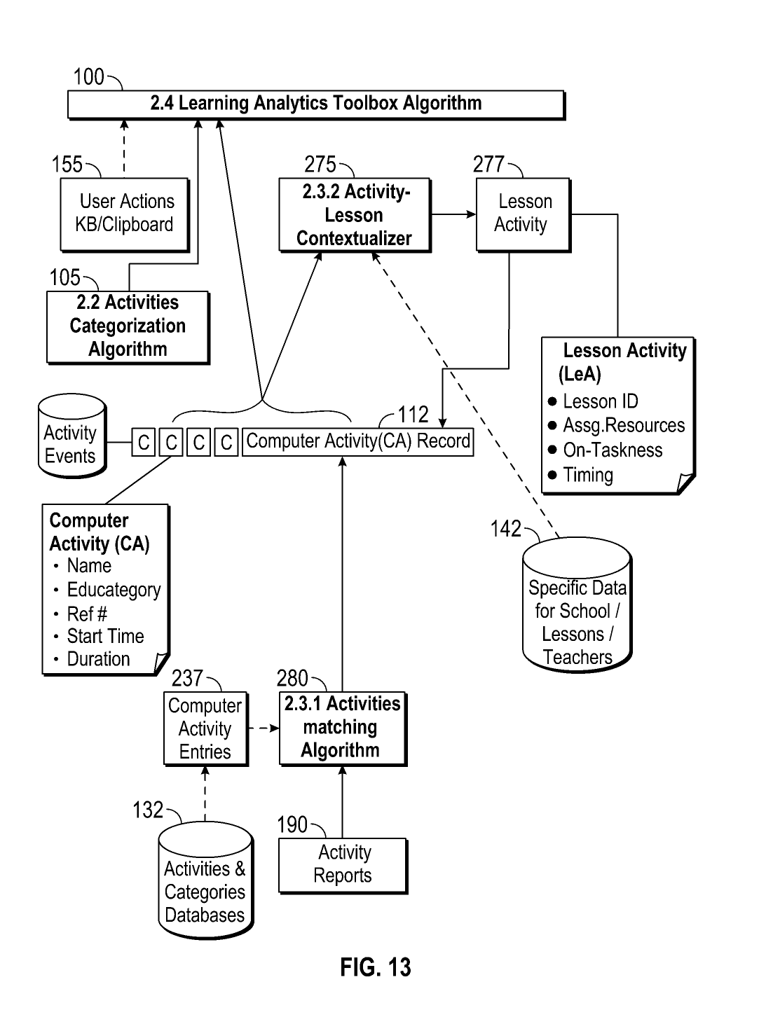

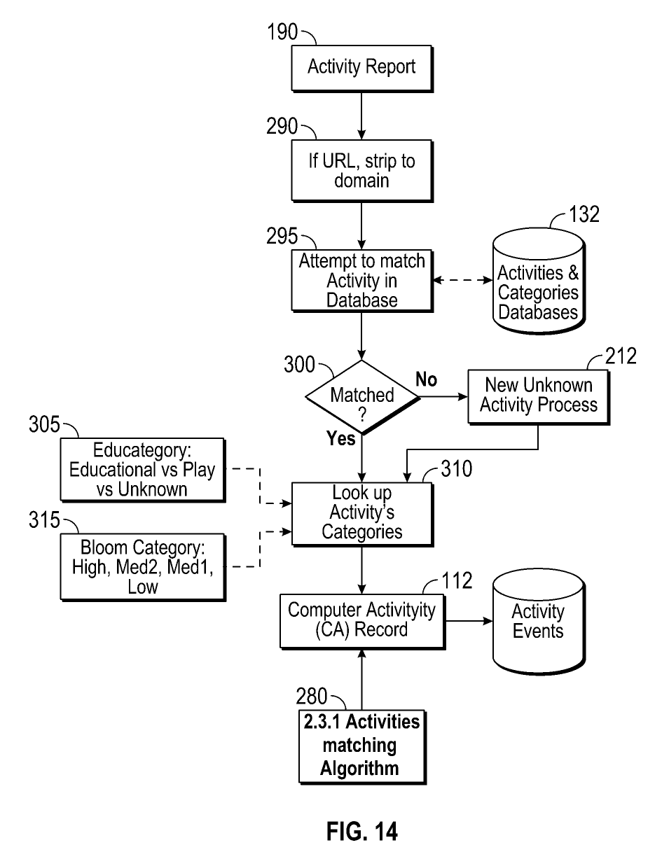

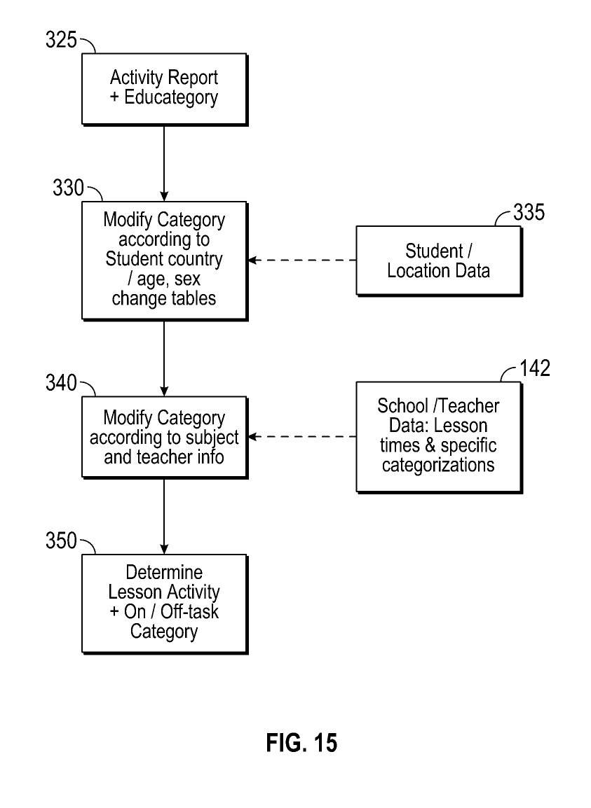

FIG. 13—Item 105 (FIG. 9), Level 2.3 Activity Categorization Algorithm. This figure provides a detailed flowchart of a representative example of an activity categorizer algorithm (105) useful in the practice of this invention. In this example, the activity categorization algorithm (105) takes as input data from an activity report (190) generated by an activity collection/detection algorithm (140) on the student's computer. An activities matching algorithm (280; see FIG. 14 and corresponding detailed description) matches the one, some, or all of the activities in the activity report (190) with corresponding computer activity entry(ies) (237) in the reference categories database (132) to generate computer activity event record(s) (112) that are then stored in a large database. Preferably, each activity is then placed into a contemporaneous lesson context by an activity lesson contextualizer algorithm (275, see FIG. 15 and corresponding detailed description), resulting in a lesson activity (277), the details of which are then preferably stored back in the computer activity record (112). Computer activity records (112), along with student actions (155), are inputs into the FLA application.

FIG. 14—Item 280 (FIG. 13), Level 2.3.1 Activities Matching Algorithm. This figure describes a representative activities matching algorithm (280) that can be used in practicing the invention. This algorithm, and software (or other computer control logic) embodying it, provides the following functionalities in order to define an activity's identity and educationally categorize it:
Strip URL of any resource(s) to its domain name and then attempt to look up the domain name in the activity categories database (132)
If an activity category for the domain name is found in the activity categories database (132), the activity category is retrieved
If the domain name and corresponding activity category is not found in the activity categories database (132), the domain is considered a “new” activity
Any new activity is added to activity categories database (132) and one or more activity categories are assigned from a domain string analysis, harvesting of teacher manual assignments, manual classification by staff, from website-type lookup, and type to education category table lookup
Activities categories include on-task versus off-task activities, system-based (e.g., computer operating system) activities for Ignore, HigherThinking Category

In this example, the activity-matching algorithm accepts as input data from an activity report (190). If the data corresponds to a URL, the URL is preferably first converted by algorithm to a more generic domain name, for example, by removing resource specifiers from the URL (290) and then attempting to match the resulting more generic domain name with the closest activity in activities database (132). If no match is found by this test (300), a new unknown activity (212) is assigned to the URL (and its genericized permutation(s)) and added to the activities database (132) as a yet unknown category, pending revision of further updating by an update method (135). Otherwise, activity educational categories for the URL (and its genericized permutation(s)) are defined (305, 315) by the system, and a new computer activity record is generated for storage in the activities database (132).

FIG. 15—Activity-Lesson Contextualizer Algorithm. This figure describes a representative activity/lesson contextualizer algorithm that can be used in the practice this invention. This algorithm, and software (or other computer control logic) embodying it, provides the following functionality: modification of activity categories by associated student actions or groupings of activities.

An activity report's (325) educational category may be modified (330) according to the student's context data (335), which may include such student-specific information as student age, sex, class (e.g., 1st grade, 6th grade, etc.), parent(s)/guardian(s), country, state/province, county, city, school, school district, and may also be modified (340) according to school and teacher data, e.g., school, school district, teacher name, class/subject name, teacher-specified resources, etc., and may also include a specific category override to allow, for example, a teacher of the student to override or name the educational category for the particular activity. When an override function is provided, the system preferably tracks information related to any such override (e.g., date of override, source of override (e.g., identification information for the computer or other device from which the override was made), the information changed by the override, etc.) for subsequent review, if desired.

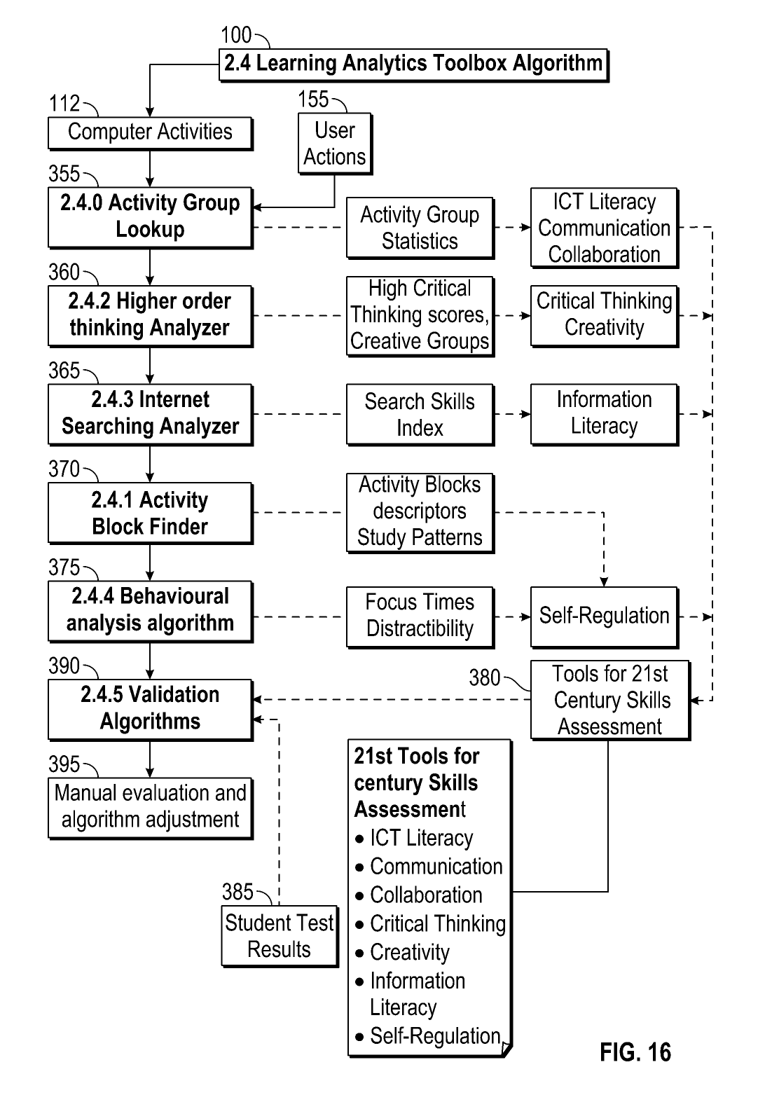

FIG. 16—Item 100 (FIGS. 9, 10, 13), Level 2.4 Learning Analytics (LA) Algorithm Toolbox. This figure shows the hierarchical organization of a representative pedagogical learning analytics (LA) algorithm toolbox, a preferred example of an FLA application according to the invention. As shown, the FLA application accepts computer activities (112) and user actions (155) as inputs and outputs a set of parameters helpful in assessing a student's competencies relevant to 21st Century skills (380). In this example, each computer activity (112) is first further categorized and assigned by an activity group lookup function (355) to a generic activity group, which can then be statistically summarized so that the breadth and sophistication of a student's information and communications technologies (ICT) application use can be calculated from scoring tables. In addition, the amount, type, and identity of communication and collaboration applications used by the student can be calculated. In preferred embodiments, the FLA application may define and determine occurrences of, for example, meta-activities, which can be defined, for example, as pairs or triplets of recurring activities, such repeating patterns of use of a website, copying information to a clipboard, work processor use, cut and paste function use, etc., which suggests computer-based information collection by the student.

Activities for the student may then be scored for higher-order thinking (for example, by using a higher order thinking analyzer (360). For instance, the system can distinguish between the student's use of a science simulation program versus her/his passively watching a video on her/his computer or other device. Also, in preferred embodiments, a student's Internet search skills, based on an automated analysis of search queries used, can be scored by, for example, an Internet searching analyzer (365).

In such embodiments, activities are parsed for blocks of study using an activity block finder (370), which, for example, can be determined from predominant learning activities weighted to 5-90 minute period windows and behavioral parameters of focus times and distractibility, as can be calculated from uninterrupted durations of learning activities and frequency of interruptions by non-learning activities, respectively. Patterns of block study and behavior therein can be combined into scores that reflect the student's self-regulation. Results from these various automated tools can then be summarized in a generalized high level skills set, for example the currently popular 21st Century Skills, assessment toolbox (380) for teachers and other authorized stakeholders (e.g., the particular student, her/his parent(s)/guardian(s), school administrators, school counselors, etc.). In a preferable implementation, student test results, uploaded from one or more schools, can then be correlated with the above indices, and correlations tested by interventional trials and prospective data collection to obtain validation by educational experts to iteratively improve and validate the design and implementation of such an LA algorithm toolbox.

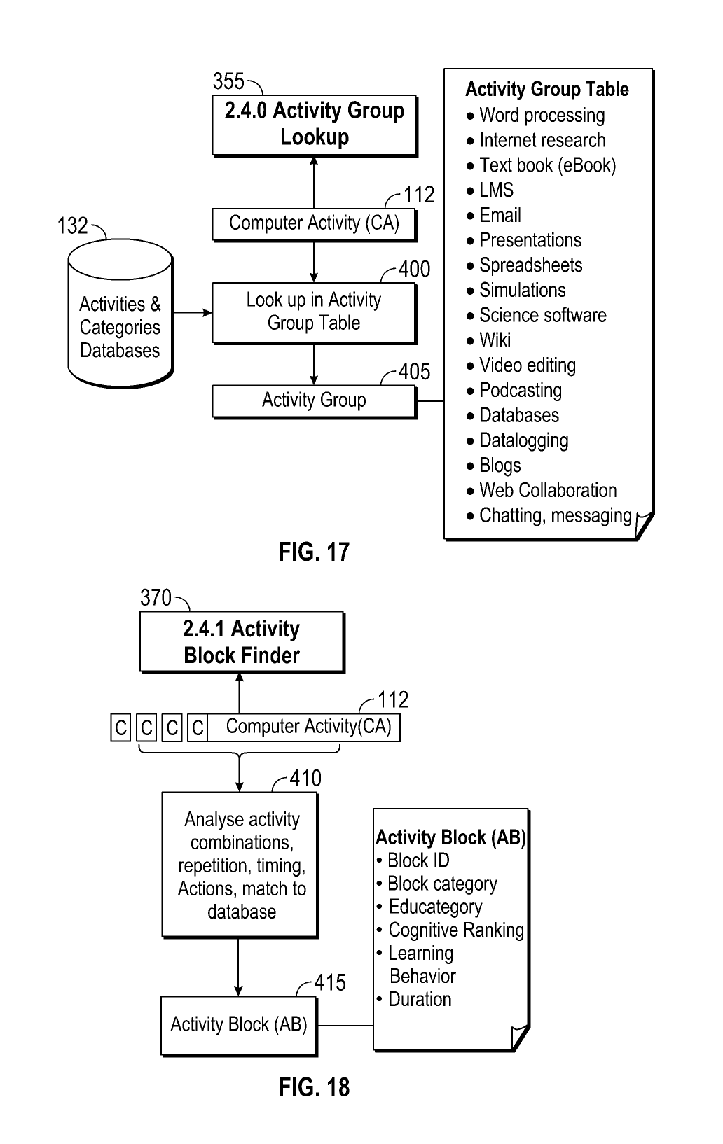

FIG. 17—Item 355 (FIG. 16), Computer Activity Group Lookup Algorithm. This figure provides a flowchart for a representative algorithm designed to look up each specific or proprietary computer activity (112) that a student engages in while using her/his computer or other electronic learning device. Here, a lookup table within the activity categories database (132) (or elsewhere, but accessible to the FLA application) is used to assign the activity to a generic activity group (405). For example, the system could categorize a student's access or use of Facebook via her/his computer as a “social networking group” activity or the like, while her/his use of Microsoft Excel could be categorized as a “spreadsheet” activity. In some embodiments, the system can generate a generic computer activity report, some or all of the data in which may be used as inputs for other FLA application functions.

FIG. 18—Item 370 (FIG. 16), Student Activity Block Finder Algorithm. FIG. 18 provides a flowchart for a representative algorithm designed to identify blocks of similar computer use by a student, such as studying, viewing movies, etc.

As will be appreciated, it could often be advantageous to infer from a student's computer-related activities when s/he may have engaged in identifiable periods of relatively sustained learning-related activities. Such activities may correspond to classes during school hours, as well as to “doing homework” outside of school hours. To this end, in a representative example of an activity block finder algorithm (370), the activity block finder tool repeatedly parses the student's computer activity records (112), or, alternatively or in addition to parsing the generic activity group records for the student, over a defined time period of interest to identify long periods, for example, between 5 to 90 minutes, of maximum learning content. This may be accomplished, for example, by dividing the student's daily computer-related activities into 5-minute increments, summing the learning content score of each, plotting the smoothed (depending on time period of interest, e.g., ‘moving box car’ of 5) values on a timeline, and then finding the relative maxima above a threshold based on that student's history or on data labels to define study blocks.

In preferred some embodiments of this tool, the system can automatically adjust the periods used for parsing a student's activity records and to define periods that are useful in order to infer what activity(ies) a student has engaged in during a certain period of computer use. For example, when an FLA system according to the invention initially begins tracking a student's computer use, a predefined time period may be used, for example, to set the periods for periodic parsing of the student's computer activity records and/or the minimum length of time the student must have been engaged in a particular activity (actual or generic) in order for an activity block finder tool to identify it as such. Over time, the system may adjust these periods automatically based on results for the particular student, groups of similarly disposed students, etc.

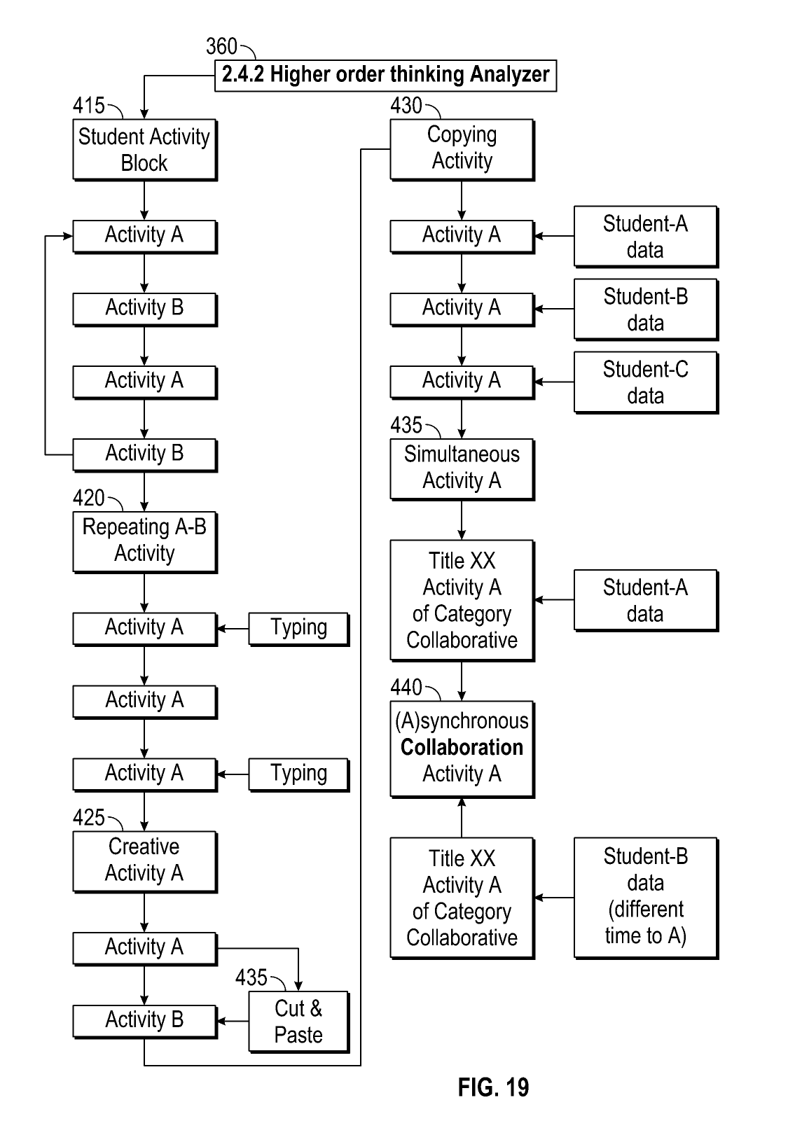

FIG. 19—Item 360 (FIG. 16), Activity Higher Order Thinking Analyzer. This figure provides a flowchart for a representative algorithm designed to analyze if student activities represent higher order thinking. In preferred embodiments, such a tool determines the sophistication of the activity by systematically analyzing student study blocks (415) for combinations of activities qualified by Student Actions, starting with sequences of a repeating pair of activities, termed Repeating A-B activity (420), for example, use of a spreadsheet alternating with a word processor, suggesting writing of a report, a solitary activity such as a word processor qualified by frequent typing, suggesting higher order original or creative writing (425), as opposed two alternating activities qualified by frequent use of cut and paste, suggesting a mostly lower copying activity. The invention also indicates collaborative higher order thinking activities, either simultaneous (435), when same activity is carried out my multiple students in a class, or asynchronous collaboration (440), when different students in a class use an activity categorized as collaborative with same title at different times, for example, sharing the same file name on classroom's Google Docs drive.

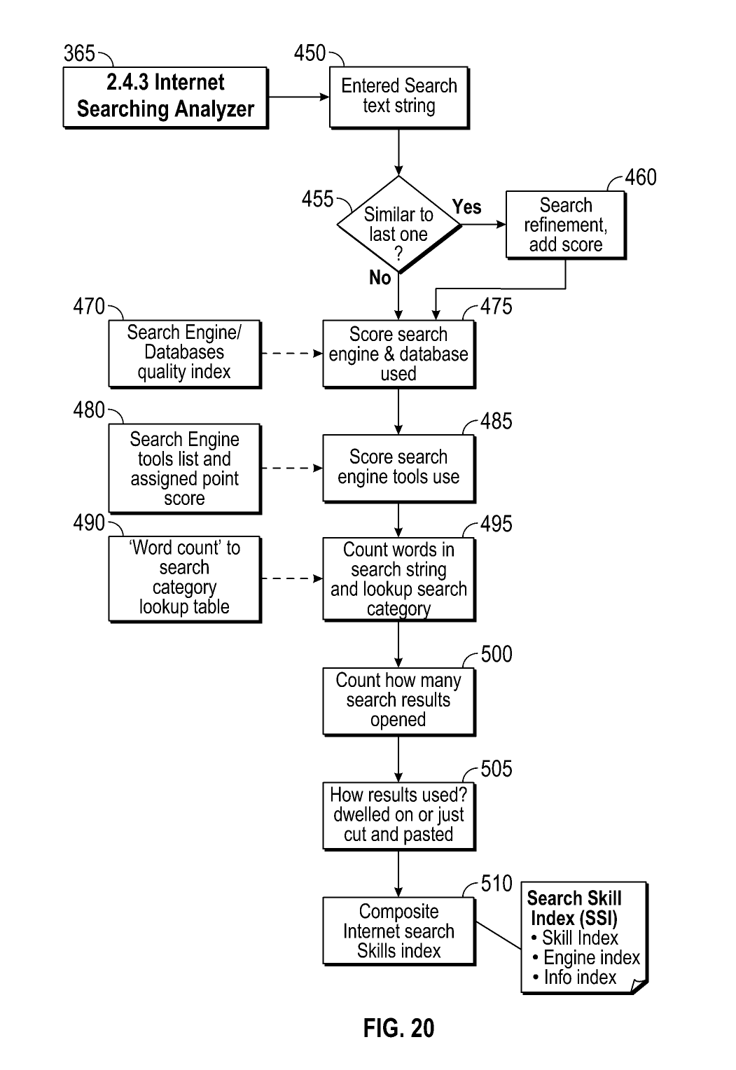

FIG. 20—Item 365 (FIG. 16), Internet Searching Analyzer.

Information literacy or finding of quality information on the Internet is a key 21st century skill. To this end, in a representative example of the Internet Searching Analyzer shown in FIG. 20, FLA, on detecting a search engine activity from a lookup table, examines the search string typically embedded in the URL (450) and determines if it is a similar string to an immediately preceding search string, indicating considered refinement of search, which is scored accordingly. The algorithm examining search strings adds score points for use of varied search engines and institutional or library databases (475) from a lookup table (470), use of search engine tools and commands (480, 485), such as use of logical operators, date restrictions, geographical restrictions, counts number of words (495) used in search string, with compound search terms scoring above single word search but below very long search strings, such as 10 words or more, which data suggests may indicate copying in whole test questions. Student examination of multiple search results, scores higher (500), as does using longer focus times on each (505), suggesting research, compared to rapid scanning and cutting and pasting, suggesting information collection. The algorithm then outputs a composite Internet search skill score (510).

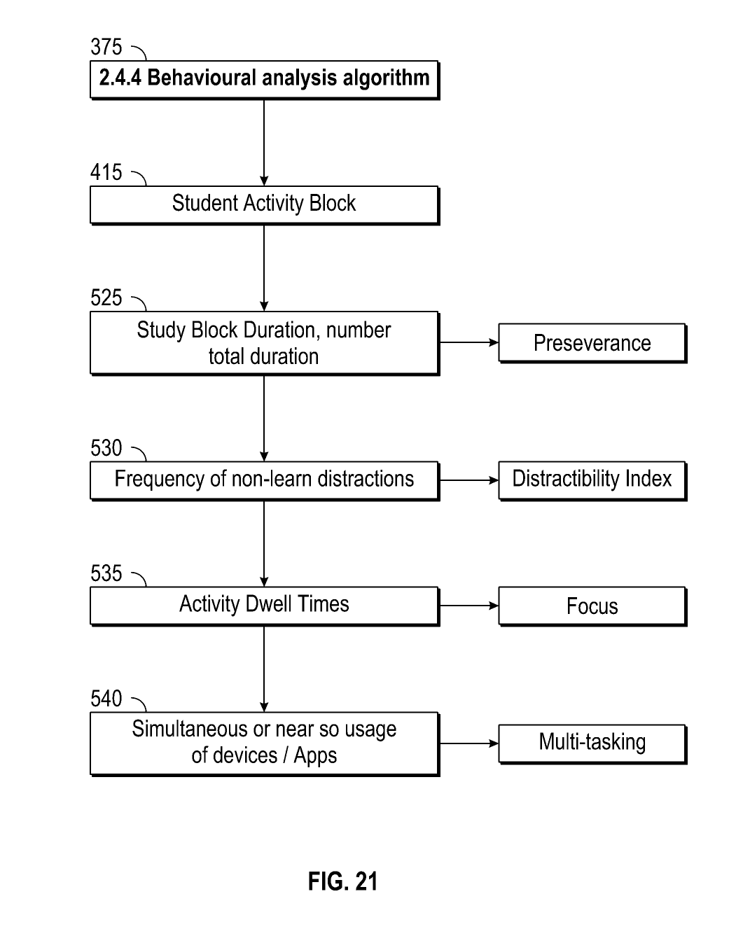

FIG. 21—Item 375 (FIG. 16), Behavioral Analysis Algorithm.

Behavioral parameters are important in learning and are a reflection of the 21st century skills of self-governance and time management. In a preferred embodiment of this invention, heuristic algorithms are used to identify indices of learning behavioral, dispositional, self-regulating, and meta-cognitive aspects of the learning process, which may influence learning as shown in FIG. 21; activity blocks (415) are described by their duration and frequency, indicating learning perseverance (525), the frequency of non-learning activity interruptions giving the distractibility index (530), dwell times on activities or some activities, excluding normally brief ones, indicating student focus, and evidence of multitasking. Each of these may be reported separately, ranked and correlated with educational outcomes.

### Data Visualization Algorithms

### Functions:

Compartmentalizes data visibility to preserve privacy and acceptability of LA by students and teachers. Restrictions on:
   Between class student-identifiable Activities visible only to Students themselves.
   Class LA data optionally visible to only the teacher, and not his superiors or administrators, controlled by roles and privileges setup.
   De-identified aggregated data for between classes and for teachers, subjects and year grades visible to all stakeholders.
Displays Live LA in classroom as feedback with traffic light simplicity and minimal input from teacher to minimize distraction from face-to-face teaching.
Displays summary and historical LA data and analyses for previous lessons for teacher reflection.
Displays results of LA analysis filterable for student, lesson, subject, teacher, year, school, etc.
Allows download of raw data
For Output screen layout, refer to Implementation above

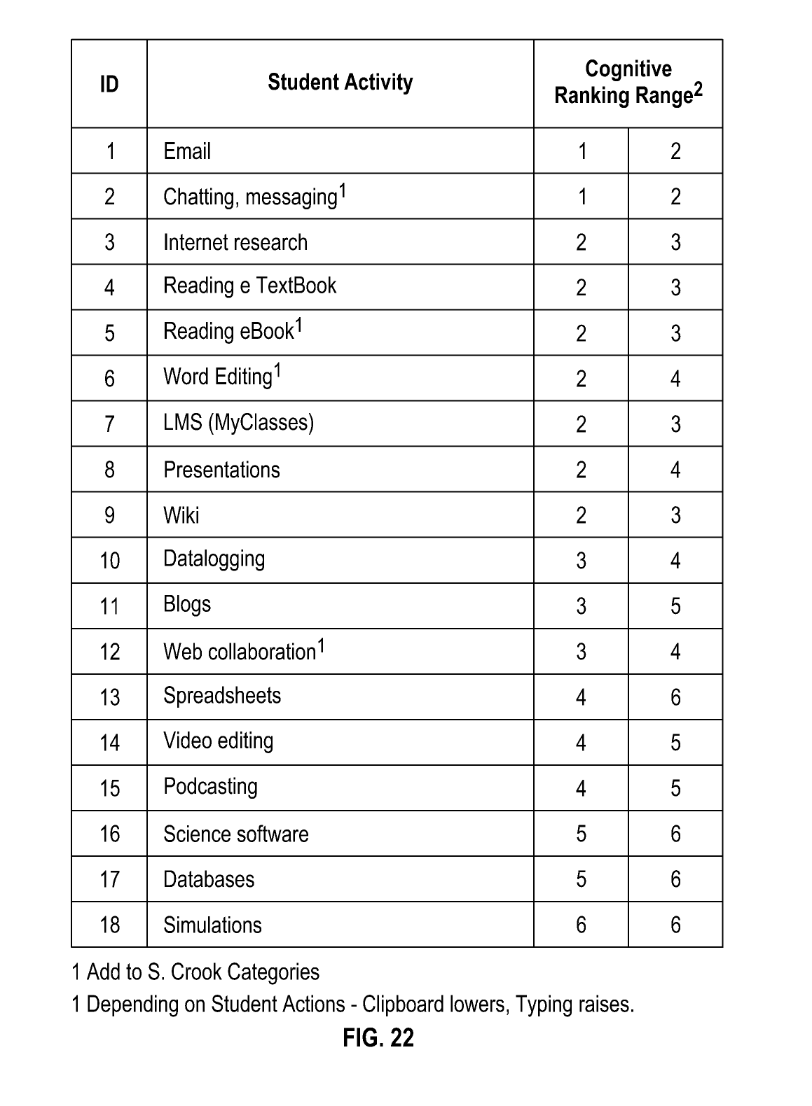

FIG. 22—List of Generic Activities and their Cognitive Level Ranges.

FIG. 22 lists the Student Activity category items, their ID, name and upper and lower cognitive ranking, modified in some upon use by qualification from student actions such as typing or cutting and pasting. For example, cognitive level of spending 20 minutes on a presentation application depends on whether student is merely reading it, or if they are concurrently typing, suggesting they are creating the presentation.

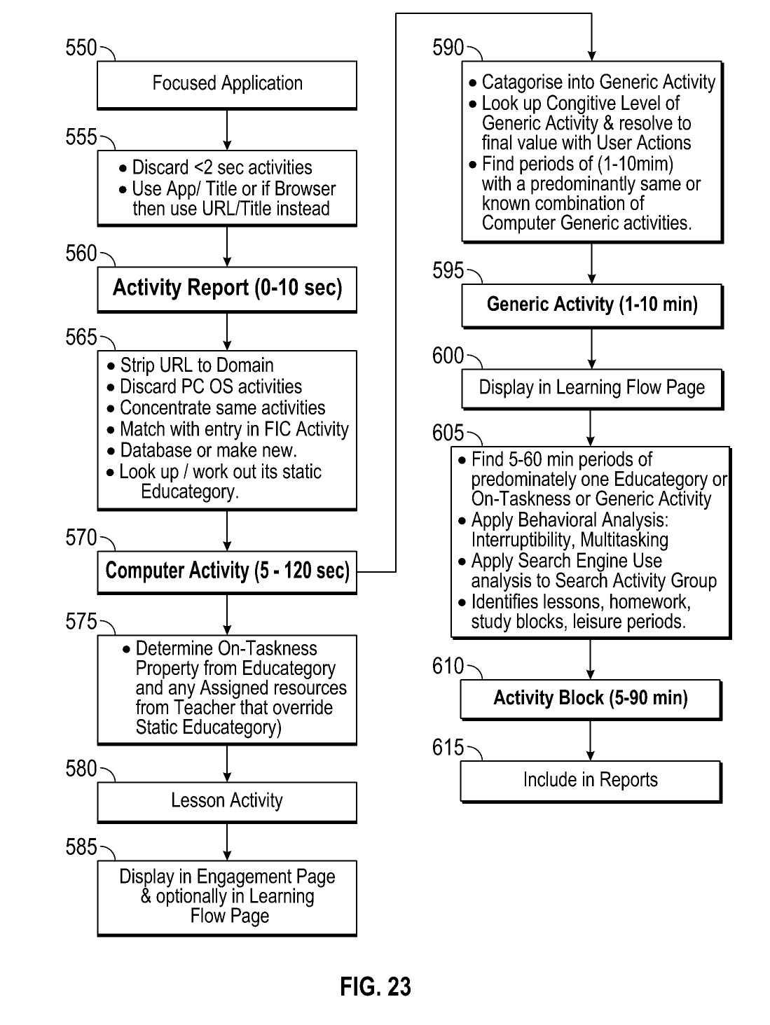

FIG. 23—Activity Analysis Hierarchy. See figure.

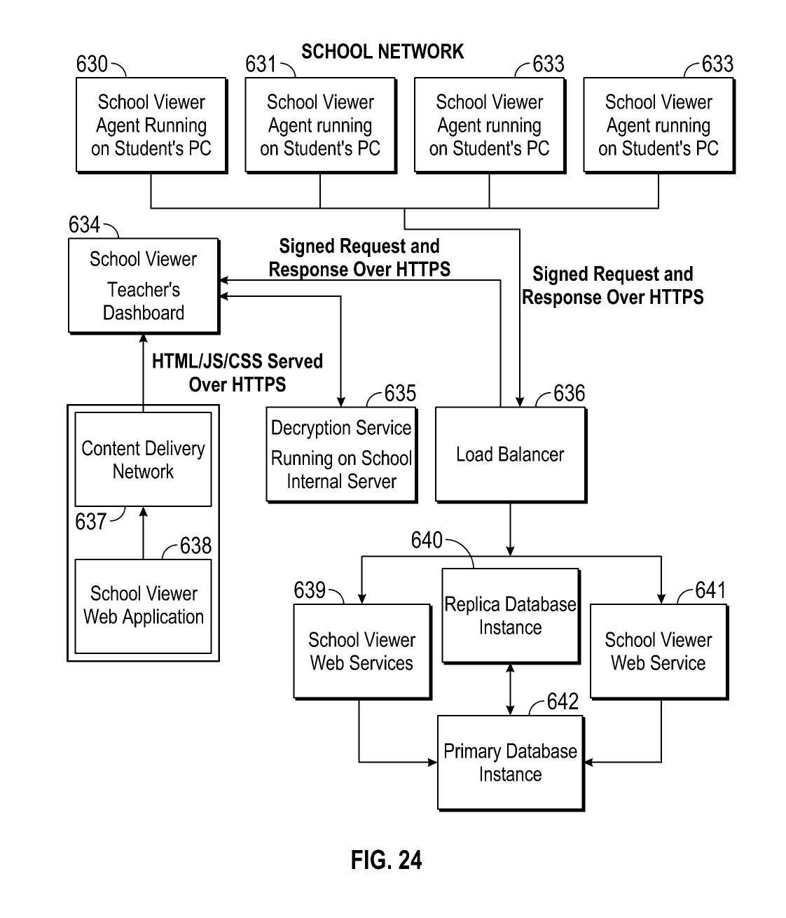

FIG. 24—System Hardware Architecture. See figure.

Those skilled in the art will appreciate that in some embodiments of the invention, the functional modules of the Web implementation, as well as the personal and the integrated communication devices, may be implemented as pre-programmed hardware or firmware elements (e.g., application specific integrated circuits (ASICs), electrically erasable programmable read-only memories (EEPROMs), etc.), or other related components. Mobile communication devices that can use the present invention may include but are not limited to any of the “smart” phones or tablet computers equipped with digital displays, wireless communication connection capabilities such as iPhones and iPads available from Apple, Inc., as well as communication devices configured with the Android operating system available from Google, Inc. In addition, it is anticipated the new communication devices and operating systems will become available as more capable replacements of the forgoing listed communication devices, and these may use the present invention as well.

In other embodiments, the functional modules of the mobile-to-cloud implementation may be implemented by an arithmetic and logic unit (ALU) having access to a code memory that holds program instructions for the operation of the ALU. The program instructions could be stored on a medium which is fixed, tangible and readable directly by the processor, (e.g., removable diskette, CD-ROM, ROM, or fixed disk), or the program instructions could be stored remotely but transmittable to the processor via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

The program instructions stored in the code memory can be compiled from a high level program written in a number of programming languages for use with many computer architectures or operating systems. For example, the high level program may be written in assembly language such as that suitable for use with a pixel shader, while other versions may be written in a procedural programming language (e.g., “C”) or an object oriented programming language (e.g., “C++” or “JAVA”).

In other embodiments, cloud computing may be implemented on a web hosted machine or a virtual machine. A web host can have anywhere from one to several thousand computers (machines) that run Web hosting software, such as Apache, OS X Server, or Windows Server. A virtual machine (VM) is an environment, usually a program or operating system, which does not physically exist but is created within another environment (e.g., Java runtime). In this context, a VM is called a “guest” while the environment it runs within is called a “host.” Virtual machines are often created to execute an instruction set different than that of the host environment. One host environment can often run multiple VMs at once.

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

### Machine Learning

In certain embodiments of the invention, the back end systems that include various servers and/or data storage use various aspects of machine learning and analytics in order to make decisions regarding which student-related educational or learning information and data to use for performing FLA analyses. For example, the systems may utilize machine-learning protocols that are used to generate heuristics and predictions based on known properties learned from training data. The software and systems of the invention may implement supervised learning protocols, unsupervised learning, semi-supervised learning protocols, transduction protocols, etc. using example inputs and their desired outputs, given by a “teacher”, with the goal to learn a general rule that maps inputs to outputs.

A teacher may be a human domain expert who uses a decision-making system to determine outcomes given specific inputs. For example, in the casino gaming industry, human experts are used to plan a gaming layout based on varied inputs like expected clientele, location of in casino restaurants, casino entertainment and time of year. In this example, the inputs are too varied for a machine alone to make decisions so a teacher is needed to provide a base set of rules by which to begin making decisions. In an analogous way, the systems of the invention can be configured to dynamically generate the one or more analytics responsive to received student learning information associated with defined events (or other defined inputs) to classify student information using machine-learning protocols employing one or more classifiers. Non-limiting examples of classifiers include Bayesian networks, decision trees, Gaussian process classifiers, k-Nearest Neighbors (k-NN), LASSO, linear classifiers, logistic regression, multi-layer perceptron, Naive Bayes, radial basis function (RBF) networks, etc.

In some cases, machine learning operates on unlabeled examples, i.e., input where the desired output is unknown. In an example of such an instance, an objective may be to discover structure in the data, not to generalize mapping from inputs to outputs. Machine learning approaches can then be used to combine both labeled and unlabeled examples to generate an appropriate function or classifier for the event (or other input) and student learning data collected. Transduction and/or transductive inferences may be used to try to predict new outputs on specific and fixed (test) cases from observed, specific (training) cases.

Certain examples can be used to partition certain student learning information into the one or more information subsets using one or more machine-learning toolboxes. Non-limiting examples of machine-learning toolboxes include dlib kernels, efficient learning, large-scale inference, and optimization (Elefant), java-ml, kernel-based machine learning lab (kernlab), mlpy, Nieme, Orange (University of Ljubljana), pybrain(Python), pyML (Python), SciKit.Learn (Python), Shogun, torch7, Waikato Environment for Knowledge Analysis (Weka), and the like.

The system may partition student learning information into the one or more information subsets using a spectral learning protocol electronically determining a rate of deviation from threshold condition. The systems may be used to partition the student learning information into the one or more information subsets using one or more of built-in model selection strategies, classification, domain adaptation, image processing, large scale learning, multiclass classification, multitask learning, normalization, one class classification, parallelized code, performance measures, pre-processing, regression, semi-supervised learning, serialization, structured output learning, test framework, and/or visualization. Further, systems may be used to generate the one or more analytics responsive to received student learning information associated with the particular event (or other input) to partition the student learning information into the one or more information subsets using a clustering protocol and generate the one or more analytics responsive to received student learning information associated with, for example, a browser event related to student learning.

Unless the context clearly requires otherwise, throughout the description above and the appended claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “hereunder,” “above,” “below,” and words of similar import refer to this application as a whole and not to any particular portions of this application. When the word or is used in reference to a list of two or more items, that word covers all of the following interpretations of the word: any of the items in the list, all of the items in the list, and any combination of the items in the list

The foregoing description, for purpose of explanation, has been described with reference to specific embodiments. However, the illustrative discussions above are not intended to be exhaustive or to limit the invention to the precise forms disclosed. Many modifications and variations are possible in view of the above descriptions. The embodiments were chosen and described in order to best explain the principles of the invention and its practical applications to thereby enable others skilled in the art to best utilize the invention and various embodiments with various modifications as are suited to the particular use contemplated. As such, the invention extends to all functionally equivalent structures, methods, and uses, such as are within the scope of the appended claims, and it is intended that the invention be limited only to the extent required by the applicable rules of law.

What is claimed is:

1. A method for visualizing free learning analytics (FLA) data for one or more students, comprising:
(a) on a student computer for each student for whom FLA data is to be visualized, an FLA application that directs (i) collection, and optionally storage, of raw activity data about the student's use of the computer, and (ii) transmission of the raw activity data to an FLA server;
(b) an FLA server connected to each student computer, which FLA server is configured for pre-processing the student's raw activity data to generate pre-processed activity data, wherein pre-processed activity data is further processed by the FLA server to generate educationally meaningful FLA data; and
(c) on the student computer and/or a third party computer, outputting for visualization at least a portion of the student's meaningful FLA data.

2. A method according to claim 1 that provides visualization of meaningful FLA data in real-time and/or historically for a plurality of students, wherein the output of a particular student's meaningful FLA data is optionally restricted to the particular student and accredited third parties, optionally her/his parent(s), educators, and school and/or district administrators.

3. A method according to claim 1 wherein the student computer is a personal computer, a tablet computer, or a smart phone.

4. A method according to claim 1 wherein the FLA application directs collection of raw activity data that reflects the totality of the student's use of her/his student computer.

5. A method according to claim 4 wherein the raw activity data comprises foreground application data about any foreground application utilized by the student when s/he uses her/his student computer, wherein the foreground application data optionally comprises at least one of foreground application name, foreground application process, and, if the foreground application process is a web browser, the URL and the URL's tab title displayed on the browser Tab, application active usage time, optionally application active usage time that exceeds two or more seconds, and idle time when no computer input is detected for a period of time e.g., from 5 seconds to 300 seconds.

6. A method according to claim 1 wherein the student's pre-processed activity data is processed by the FLA server from the students' raw activity data to generate educationally meaningful student activity data using a heuristic algorithm, wherein the heuristic algorithm optionally identifies foreground application name, foreground application process, and, if the foreground application process is a web browser, sequentially stripping from the accessed specific URL each terminal page resource string in order to identify the more generic and re-visited web page domain name, stored in a domain name database accessible by the FLA server, which more general web page domain name present in the domain name database is associated with a student activity.

7. A method according to claim 1 wherein the student's meaningful FLA data is graphically displayed on the student computer and/or a third party computer, optionally via a dashboard interface.

8. A computer system for analyzing free learning analytics (FLA) data for a plurality of students, comprising:
(a) a plurality of student computers each having an FLA application that directs (i) collection, and optionally storage, of raw activity data about the particular student's use of the computer, and (ii) transmission of the student's raw activity data to an FLA server;
(b) an FLA server capable of continuous or intermittent connection to each of the plurality of student computers, which FLA server is configured for pre-processing each student's raw activity data to generate pre-processed activity data for that student, wherein pre-processed activity data for that student is further processed by the FLA server to generate meaningful FLA data for that student; and
(c) one or more output computers configured to output, optionally for visualization, at least a portion of the meaningful FLA data for at least one of the students, wherein the output computer(s) is(are) a student computer and/or a third party computer.

9. A computer system according to claim 8 that further provides for visualization of meaningful FLA data in real-time and/or historically, wherein the output of a particular student's meaningful FLA data is optionally restricted to the particular student and accredited third parties, optionally her/his parent(s), educators, and school and/or district administrators.

10. A computer system according to claim 8 wherein the student computer is a personal computer, a tablet computer, or a smart phone.

11. A computer system according to claim 8 wherein the FLA application directs collection of raw activity data that reflects the totality of the student's use of her/his student computer.

12. A computer system according to claim 11 wherein the raw activity data comprises foreground application data about any foreground application utilized by the student when s/he uses her/his student computer, wherein the foreground application data optionally comprises at least one of foreground application name, foreground application process, and, if the foreground application process is a web browser, the URL and the URL's tab title, application active usage time, optionally application active usage time that exceeds two or more seconds, and idle time.

13. A computer system according to claim 8 wherein the student's pre-processed activity data is processed by the FLA server from the students' raw activity data to generate meaningful student activity data using a heuristic algorithm, wherein the heuristic algorithm optionally identifies foreground application name, foreground application process, and, if the foreground application process is a web browser, sequentially stripping from the accessed URL each then-terminal page resource string in order to identify a more generic web page domain name present in a domain name database accessible by the FLA server, which more general web page domain name present in the domain name database is associated with a student activity.

14. A computer system according to claim 8 wherein the student's meaningful FLA data is graphically displayed on the student computer and/or a third party computer, optionally via a dashboard interface.

15. A server computer, comprising:
(a) a central processing unit (CPU) configured for continuous or intermittent connection to each of the plurality of student computers, which FLA server is further configured for pre-processing each student's raw activity data to generate pre-processed activity data for that student, wherein pre-processed activity data for that student is further processed by the FLA server to generate meaningful FLA data for that student;
(b) a memory functionally associated with the CPU; and
(c) a power supply.

16. A server computer according to claim 15 that is further configured to output meaningful FLA data for a student, which data is transmitted over a computer network that includes the server computer to a student computer and/or a third party computer for visualization of at least a portion of the student's meaningful FLA data.

17. A server computer according to claim 15 wherein the student's pre-processed activity data is processed by the server computer from a student' raw activity data to generate meaningful student activity data using a heuristic algorithm, wherein the heuristic algorithm optionally identifies foreground application name, foreground application process, and, if the foreground application process is a web browser, sequentially stripping from the accessed URL each then-terminal page resource string in order to identify a more general web page domain name present in a domain name database accessible by the FLA server, which more general web page domain name present in the domain name database is associated with a student activity.
